(19) United States
(12) Patent Application Publication
(10) Pub. No.: US 2018/0240101 A1
(43) Pub. Date: Aug. 23, 2018

(54) SYSTEM OF ASCERTAINMENT

(71) Applicant: MARCH PROJECTION LIMITED, HONG KONG (CN)

(72) Inventor: Mark Kit Jiun CHAN, Hong Kong (CN)

(21) Appl. No.: 15/530,735

(22) Filed: Feb. 23, 2017

(51) Int. Cl. G06Q 20/32; G06Q 20/20

(52) U.S. Cl. CPC G06Q 20/3278; G06Q 20/3223; G06Q 20/206

(57) ABSTRACT

A system, apparatus and method characterize a user with properties, including data in proximity and mobility of a mobile device pertaining to the location and browsing activities at a juncture. A data storage medium maintains a database of information used in an ascertainment process; through the mobile device in possession, a user is ascertained with the pertinence of an account associated with the mobile device and operations entailing user identity.

### FIELD OF INVENTION

The present application claims the priority benefits of U.S. Provisional Patent Application No. 62/296,625, filed 18 Feb., 2016, under title “Electronic Payment System”. The field of invention generally relates to prevention of fraudulent use of user account in an operation, through verifying user identity and ascertaining user pertinence on the basis of data of user communication device.

### BACKGROUND ART

The World Wide Web has paved way for ubiquitous online activities in addition to controls of smart devices; to sustain related operations, incumbent technologies entail user identification, including data encryption in transport, password entry, biometric scanning, etc. Contactless smart card with a standardized protocol in a data transfer mechanism (e.g., ISO 14443/NFC) is rife, yet user account information can be stolen and cloned in illegal abuse.

### SUMMARY OF INVENTION

In a fundamental aspect of the disclosed subject, the operating principle entails correlation of the user and communication device in pertinence and proximity. In one embodiment, the ascertainer locates and records with respect to time data pertaining to the location, surroundings (“proximity data”), of a tracked user carried communication device possessing a unique identifier other than the IP address—with wireless telematics communicative capability (“mobility”, such as a smartphone, as an example), or, without wireless telematics communicative capability (“computing device”). The communication device transmits real-time proximity data to the ascertainer through a network, which includes a combination of landline and wireless communicative infrastructure. The ascertainer ascertains communication devices as “venue related”—by performing a process—to at least one access point (“AP”) disposed environment at a geographic location (“geo-location”) acknowledged as a regular user visited location in accordance with user location records, and related to one another as devices that are “peering related”.

### Technical Problem

Fraudulent use of user account information in credit card, payment card in POS transaction, ATM cash withdrawal, online purchase is rife—the most commonly used solutions are restricted to coding related.

### Solution to Problem

According to a primary aspect of the disclosed subject, the ascertainer performs user validation processes on the basis of the concurrent and tracked communication device proximity data, pertaining to the geo-location or surrounding short-range wireless access points for linkage, and “mobility data”, comprising: web browsing history with a unique identifier of the device, IP address, and communicatively linked wireless AP (“venue AP”) IP address, record of a code, or the like

In one aspect of the disclosed subject, a communication device opens up a series of web pages in a browsing path in an online operation that requires a user to transmit account information to a host; the communication device is imbedded with a client application, which is capable of recording, retrieving, importing (from another installed web browser) and exporting the mobility data to the ascertainer in an online user validation process to justify the pertinence between the online operation and the incumbent communication device. The ascertainer generates a status indicator (to be discussed further below) to demonstrate the result of the online user validation process. “Web browsing history” relevance to the online operation, ascertained in an online user validation process, comprises at least one of the following web browsing activities recorded with respect to time, within a time period or first threshold from the time of operation that transmits the user account information (“validation time”): browsed web pages entailed for performing the online operation, activated icons/links, first identifier of the communication device imbedded client application exporting the user account information, and the like.

According to another aspect of the disclosed subject, user account information is obtained by a host operated access device; whereas, a validation request message is received by the ascertainer, which performs a user validation process—proximity between the host and mobility at a validation time must be within a preconfigured proximity threshold to be deemed valid, and therefore implementation of an access device operation.

### BRIEF DESCRIPTION OF DRAWINGS

FIG. 1 illustrates an embodiment of a system with an ascertainer.

FIG. 2A is a schematic representation of a communication device, comprising a controller imbedded with a client application.

FIG. 2B is a schematic representation of the controller as a mobility.

FIG. 2C is a schematic representation of the controller as a computing device.

FIG. 3 is a schematic representation of a communication system operation through short-range wireless pairing with an access point.

FIG. 4A depicts a database 400 comprising data demonstrating whether or not a communication device is acknowledged as related to an account.

FIG. 4B depicts a database 410 comprising client device IP database 10.1.

FIG. 4C depicts a host proximity data storage structure 420 of a location database 10.2.

FIG. 5A depicts a venue AP list 500 comprising access points available for providing short-range wireless pairing.

FIG. 5B depicts an exemplary schematic representation of stored web browsing history data in a web browsing history 510.

FIG. 5C depicts a database comprising a user blockchains path 520.

FIG. 6A is a schematic representation of a communication system.

FIG. 6B depicts a website 650 pertaining to an online store.

FIG. 6C depicts a communications group 680 for online fiscal transfer.

FIG. 7 is a flowchart of an online user validation process.

FIG. 8 is a flowchart of a user validation process.

### DESCRIPTION OF EMBODIMENT

The present invention provides methods and apparatuses to ascertain online user validation process on the basis of web browsing activities recorded with respect to time, and, user validation process on the basis of proximity between a user communication device and an access device.

The following discussion references various embodiments, which should not be construed that the disclosure is merely limited to specifically described embodiments. Instead, any combination of the following features and elements, whether related to different embodiments or not, are contemplated to implement and practice the disclosure. Although embodiments may achieve advantages over other possible solutions, prior arts, whether or not a particular advantage is achieved by a given embodiment is not limiting of the disclosure. Likewise, reference to “the disclosure” shall not be construed as a generalization of any subject matter disclosed herein and shall not be considered as an element or limitation of the appended claims except where explicitly recited in a claim(s).

As will be appreciated, aspects of the present disclosure may be embodied as a processor mounted system, method or computer program product; and, accordingly take the form of an entirely hardware embodiment, an entirely software embodiment (including firmware, resident software, micro-code, etc.), or an embodiment combining hardware and software aspects that may generally be referred to herein as a “module”, “device” or “system.” Furthermore, aspects of the present disclosure may take the form of a computer program product embodied in one or more non-transitory computer-readable medium(s) having computer-readable program code encoded thereon.

Any combination of one or more non-transitory computer-readable medium(s) may be utilized, including a computer-readable signal medium or a computer-readable storage medium which may store data which may be read by a computer system. A computer-readable storage medium, or memory, may be, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, an erasable programmable read-only memory (EPROM or “Flash memory”), an optical storage device, a random access memory (RAM), a read-only memory (ROM), a portable compact disc read-only memory (CD-ROM), a magnetic storage device, or any suitable combination of the foregoing. In the context of this document, a computer-readable storage medium may be any tangible medium that can contain, or store a program for use by or in connection with an instruction execution system, apparatus or device.

Aspects of the present disclosure are described below with reference to flowchart illustrations, block diagrams of methods, apparatuses (systems) and computer program products according to embodiments of the disclosure. Each block of the flowchart illustrations, block diagrams; and, combinations of blocks in the flowchart illustrations, block diagrams, can be implemented by computer program instructions, which may be stored in a computer-readable medium, provided to a processor of a general purpose computer, special purpose computer, or other programmable data processing apparatus to produce a machine, such that the instructions—when executed via the processor of the computer or other programmable data processing apparatus—create means or to function in a particular manner to implement the functions/acts specified in the flowchart; each block of the which may be executed as a computer-recordable code on a computer-readable recording medium.

The present invention also relates to a system for performing various steps and operations through data transmission and processing at various nodes. This system and node may be a specially-constructed device such as an electronic device, or, it may include one or more general-purpose computers—such as networked multiple computers or application servers—that can follow software instructions to perform the steps described herein. No limitation as to operation on a particular type of system or apparatus is implied. Software instructions may be stored in any computer readable storage medium, such as for example, magnetic or optical disks, cards, memory, and the like. No particular programming language is required; rather, any type of programming language can be used to implement the present invention, while the computer program code for carrying out operations for aspects of the present disclosure may be written in any combination of one or more programming languages.

The computer program instructions may also be loaded onto a computer, other programmable data processing apparatus, or other devices to cause a series of operative steps to be executed to produce a computer implemented process such that the instructions which execute on the computer, other programmable apparatus or other devices, provide processes for implementing the functions/acts specified in the flowchart, block diagram block or blocks.

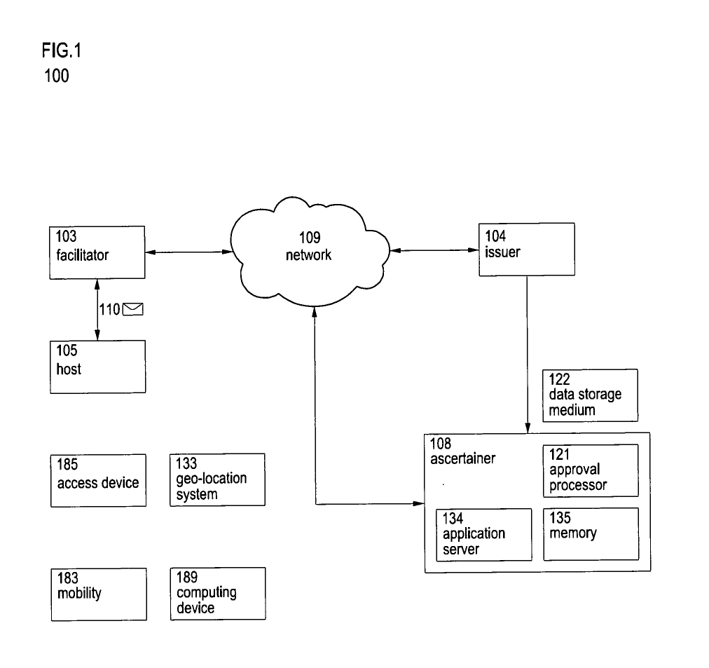

FIG. 1 is a schematic block diagram illustrating an exemplary system 100, which is without limitation any system that entails performance of a user validation process. An account (membership account issued by facilitator 103 as membership club, or payment network pertinent credit card issued by issuer 104 as bank, as examples) is issued to a user (not shown) pertaining to mobility 183 (“mobility 183 account”), for use in a host 105 pertinent operation that requires the user validation process to be performed; in one embodiment, ascertainer 108 receives a validation request message 110—generated and sent by any one of the facilitator 103, issuer 104, host 105, access device 185, or a mobility 183 account pertinent payment network (not shown)—comprising selected information without the complete account number (“safe account info”), ascertainer 108 undertakes the user validation process to ascertain the host 105 pertinent operation is authorized by mobility 183 account.

TABLE 1
[safe account info, as an example]

| Complete | Complete | |
|---|---|---|
| account number | account name | Safe account info |
| 3002 1212 2020 2998 | Adam Kevin Smith | AKSmith30021212 |

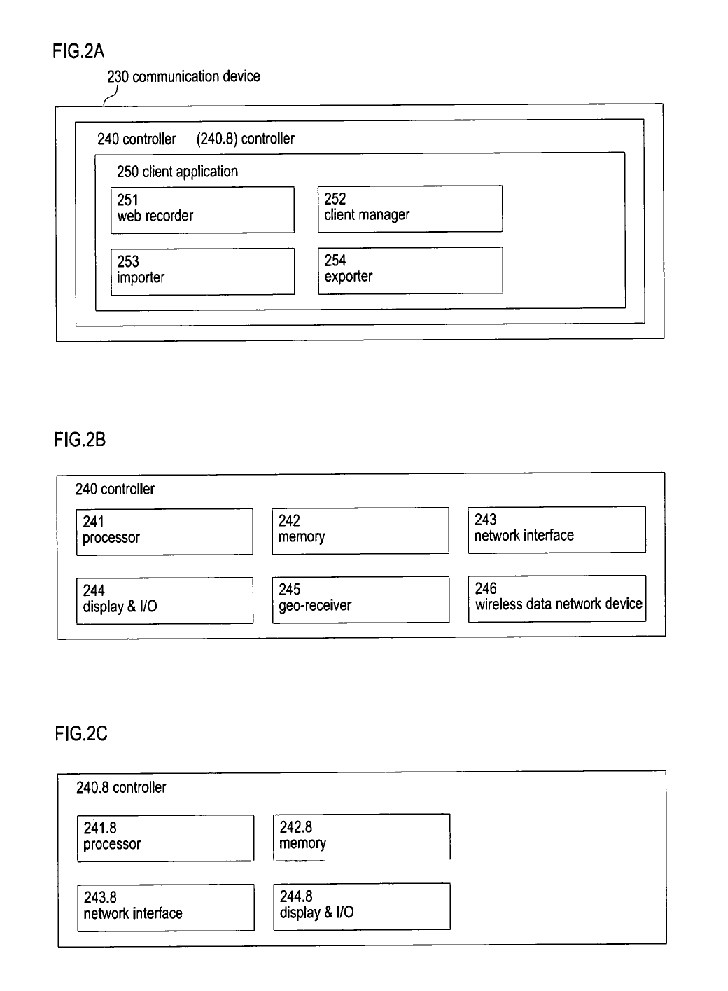

According to some embodiments, validation request message 110 may be an electronic message associated with a mobility 183, comprising some of the following: a mobility 183 identifier (comprising a unique identifier, phone number, the incumbent client application 250 first identifier (FIG. 2A), as examples), identification information of a mobility 183 account, validation time, address of a location, geo-location data, host 105 descriptive information—comprising the Host Identification Number (HID) of the host 105, Terminal Identification Number (TID) of an access device 185 activating an operation, information of a facilitator 103 issued host 105 account (“host 105 account”), for a user validation process—and any other information that may be utilized in determining to identify, whether to authorize an operation.

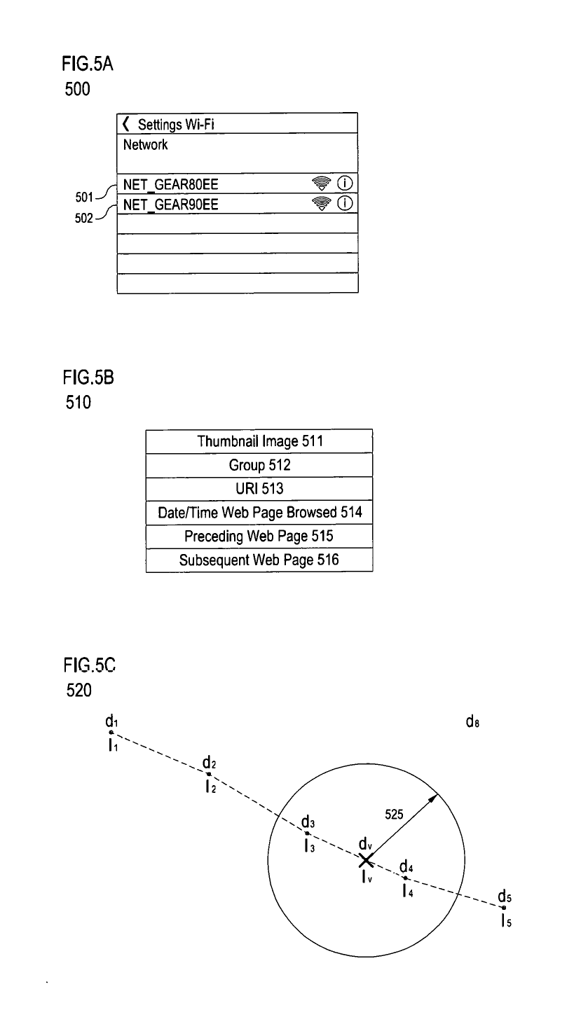

Proximity data—pertaining to a plurality of locations of hosts 105 where access devices 185 are operated, mobilities 183—comprises longitude and latitude coordinates, or by an identifiable location such as a city, postal code, street address, flat unit in a building, name of a venue, or any other information suitable to identify a distinctive location. In another aspect, proximity data encompasses a venue AP list 500 (as shown in FIG. 5A) of network 109 linked APs 107 available for communicative linkage with a mobility 183 or computing device 189 through short-range wireless pairing at the present location. In furtherance, proximity data is a proximity log, which will be discussed further.

AP 107 (equipped in access device 185, or disposed in a venue, as examples)—such as beacon, gateway, WiFi router—may comprise a reader, with a unique identifier, and capability to provide short-range wireless pairing with mobility 183 or computing device 189, and transport of information to network 109.

Ascertainer 108 comprises an approval processor 121 (a processor mounted network linked application server or control system, as an example), data storage medium 122. Approval processor 121, comprising one or more modules (not shown), processor mounted servers, functioning with combinations of hardware or software components to record, change, update, send, receive or erase data and information stored in the operatively coupled data storage medium 122. The one or more modules may be programmed or configured to maintain and update a data storage medium 122 stored client device IP database 10.1, and location database 10.2.

Although FIG. 1 illustrates the data storage medium 122 as a single entity, the invention is not so limited. For example, some data pertaining to the client device IP database 10.1 can be stored in the memory of a mobility 183 (as discussed further below).

In one embodiment of the subject invention, a tracking system of ascertainer 108 is linked with network 109 and includes application server 134—comprising multiple computers or processor mounted application servers, and memory 135. The tracking system operates with a plurality of user mobile devices 183 and computing devices 189, network 109 linked APs 107, access devices 185 processing mobile devices 183 account pertinent operations, and the geo-location system 133, to track and record the geo-location of user mobile devices 183 with respect to time.

Geo-location system 133 is a terrestrial or satellite based Global Navigation Satellite System (GNSS), including the Beidou Navigation System, Differential GPS (DGPS), Eurofix® DGPS, Global Positioning System (GPS). In other trilateration based positioning systems, geo-location system 133 comprises systems providing reference points, or cellular communication towers, transmitting RF signals received by mobility 183.

Application server 134 may be any processor mounted and software imbedded equipment capable of facilitating two-way data communications with multiple mobilities 183 and computing devices 189—and in a further embodiment, access devices 185—through network 109; application server 134 is configured to receive via the network 109 and record in memory 135 for ascertainer 108 information including identifier pertinent proximity data from a host 105, mobility 183, access device 185, and computing device 189, and, mobilities 183 or computing devices 189 mobility data. In another embodiment, application server 134 determines the geo-location of a mobility 183, or computing device 189, by matching the unique identifier of host 105 installed AP 107—comprised in the records (“pairing record”) encompassing short-range wireless “pairing” and “unpairing” (using Bluetooth™, WiFi, as examples) with AP 107 sent by the communicatively paired mobility 183 or computing device 189—with the location database 10.2 stored AP 107 identifier pertinent geo-location. In one embodiment, a mobility 183 imbedded client application 250 (as shown in FIG. 2A) shares the incumbent proximity data with a software program running in the application server 134 that logs and interprets the proximity data (as described in more detail below).

A library of predefined geo-fence boundaries, the polling interval at constant or variable frequency directing data logging between application server 134 and mobility 183, or computing device 189, quantitative calculations performed by application server 134, and other information such as personal data of the user of mobility 183 or computing device 189, is stored in the memory 135 and retrieved by the application server 134.

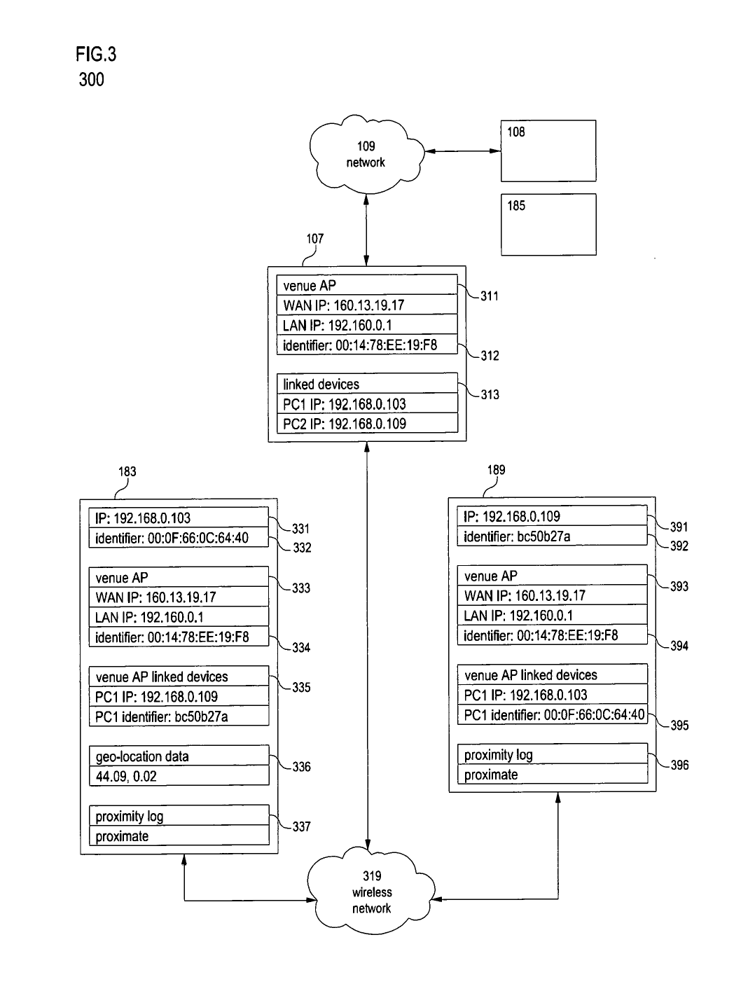

Data storage medium 122, working with or within the communicatively coupled approval processor 121, can be any device, including magnetic, optical or solid-state memory; where stored information can be changed by the approval processor 121, or application server 134. Data storage medium 122, storing instructions and coding, when executed by the one or more processors of the approval processor 121, are configured to cause the one or more processors to execute methods discussed in conjunction with FIGS. 3-8.

Network 109 can include the Internet in addition to local area networks (LANs), wide area networks (WANs), direct linkages, such as through a universal serial bus (USB) port, other forms of computer-readable media, or any combination thereof. On an interlinked set of LANs, including those based on differing architectures and protocols, a router acts as a link between LANs, enabling messages to be sent from one to another: communication links within LANs typically include twisted wire pair or coaxial cable; communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Network 109 is enabled to employ any form of computer-readable media for communicating information from one electronic device to another, configured to couple various mobilities 183 and computing devices 189 and with each other though wireless linkage. In essence, network 109 includes any communication method by which information may be transported between one device to another, and transports information to and from one or more other networks; remote computers and other related electronic devices could be remotely linked to either LANs or WANs via a modem and temporary telephone link.

In an indoor tracking environment, the network 109 wireless and landline communication infrastructure typically includes a combination of Ethernet and WLAN. Mobility 183 and computing device 189 possessing short-range wireless communicative components and functionality are continually tracked through an AP 107 node based mesh network (not shown) comprising a plurality of APs 107, which transmit short-range wireless signals to a mobility 183 or computing device 189, and transport the returning signals to the application server 134. Whereas, in an outdoor environment, network 109 includes a combination of wireless and landline communication infrastructure such as a cellular telecommunication system and the Internet.

Mobility 183 is a processor and memory mounted device used in digital cellular systems possessing radio frequency (RF) based systems (802.11 based wireless communication, Bluetooth™, NFC, WiMAX, Zigbee, WiFi), short-range wireless, wireless telematics communications functionality (“telematics functionality”), capable to send, request and receive data over network 109—which can be a personal digital assistant (PDA), cellular phone or smart phone such as a Blackberry®, an Android® device, or an I-Phone®, operative with subscriber based wireless data communication networks such as the 3G network or 4G network, code division multiple access (CDMA), EvDO, EDGE network, enhanced specialized mobile radios (ESMRs), personal communications systems (PCS), or any combination thereof; it displays graphical user interfaces and is able to activate a client application 250 possessing functionality as a web browser, through which a user can implement the subject matter of performing a user validation process pertinent operation.

Mobility 183 is also configured to obtain and record the present proximity data by receiving and processing geo-location system 133 sent signals with imbedded hardware or software components, or a combination of both; some exemplary technology may include the GPS, etc. In a further embodiment, mobility 183 determines its geo-location by engaging in the trilateration process, and transmits coded wireless messages—comprising the unique identifier, and present geo-location, or, geo-fence centric projected lead time from a location (as discussed further below)—at constant or variable specific frequency in time as per the preconfigured periodic or intermittent polling interval in operative settings to the application server 134; alternatively, mobility 183 transmits the coded wireless messages standalone or at a defined polling interval in accordance with received application server 134 sent standalone or periodic probe requests.

Computing device 189 is a processor and memory mounted device possessing short-range wireless, radio frequency (RF) based systems (Bluetooth™, NFC, WiMAX, Zigbee, WiFi or 802.11 based wireless communication), without telematics functionality, such as an I-Pad®. Typically, mobility 183 and computing device 189 are configured to generate with respect to time and record pairing records with an AP 107, and configured with operating parameters to generate and transmit coded wireless messages comprising the concurrent proximity data or the unique identifiers of the APs 107—at constant or variable specific frequency in time as per the preconfigured polling interval, or upon detection of pairing—to the ascertainer 108 tracking system at any given time. Application server 134 may also be configured to generate and record pairing records in memory 135.

Mobility 183 and computing device 189 may be configured to communicate messages, through a protocol and without limit to such: email, Jabber, Internet relay chat (IRC), instant messaging (IM), Multimedia Message Service (MMS), Short Message Service (SMS), between each other, another device, or the like. Mobility 183 and computing device 189 may further be configured to include a software application to receive, send messages as mentioned above, to receive text messages and to display the message encompassed information, or include a client application 250 that is configured to provide information that identifies itself, including a capability, identifier, IP address, name, type, linked AP 107 IP address, and the like.

Consider now a communication device 230 as depicted in FIG. 2A in conjunction with FIGS. 1, 2B, and 2C. Communication device 230, imbedded with the aforementioned client application 250, comprising:
controller 240 with telematics functionality as mobility 183; or,
controller 240.8 without telematics functionality as computing device 183.

In one embodiment, client application 250 includes multiple functionality features, web browser, text and voice communication channel, as examples, and is capable of exporting to ascertainer 108 obtained and stored mobility data—comprising web browsing history pertaining to web pages browsed with the client application 250, or other installed web browsers—and proximity data. Client application 250 is also configured to extract information imported through the importer 253 for storage in the communication device 230 memory.

As used herein, client application 250 includes program modules, applications, programs, mobile apps, software, firmware, operating system coding, methods, routines, etc., and can also include a client portion of a program application that works in connection with communication device 230 and application server 134, and is not limited to a stand-alone application that runs autonomously on a communication device 230 as client, but rather refers to application on a communication device 230 that communicates with a corresponding server application hosted by application server 134.

Client application 250 interacts, according to some variation of a client-server relationship, with the ascertainer 108 to provide application services, access to web browsing history of other web browsers imbedded in a communication device 230, access to web content, and the like. In various embodiments, ascertainer 108 registers and invokes the communication device 230 through communicating with the imbedded client application 250.

Client application 250 can communicate with the ascertainer 108 to manage registration of a new client application 250, and is capable of determining, recording application characteristics corresponding to the communication device 230. In operation, for example, when ascertainer 108 detects an installation of a new client application 250 in a communication device 230, ascertainer 108 invokes the installed client application 250 to determine the characteristics thereof. These characteristics, such as proximity data pertaining to the communication device 230 (as discussed further below), user password, along with a first identifier of the client application 250 are stored in the memory 242 of controller 240, or memory 242.8 of controller 240.8, until they can be provided to the ascertainer 108.

If a complete configuration is specified, a first client application 250 is installed and configured on a communication device 230. For example, a web browser as the client application 250, can be installed in the communication device 230 and configured with a profile in accordance with the user or mobility 183 account information. Conversely, if a basic configuration is specified, then the client application 250 determines if a supported client application 250 is already installed in the communication device 230. If a supported client application 250 is installed, then the client application 250 imbedded communication device 230 automatically configures the supported client application 250. For example, client application 250 may specify a plurality of supported client applications 250, such as other apps, web browsers, or the same client application 250 installed during a complete configuration.

If a supported client application 250 is not installed, the client application 250 imbedded communication device 230 executes a secondary configuration process. In some implementations, the secondary configuration process provides user instructions to configure a plurality of second client applications 250. for example, a secondary configuration process can provide user instructions for configuring a POP3 mail account, or configuring one of a plurality of freely available web browsers. In some implementations, the secondary configuration process can be an installation of the client application 250 that is installed in the complete configuration. The installation can, for example, be subject to an approval by the ascertainer 108, as such installation may incur a per seat license fee.

If unauthenticated response data is received at the communication device 230, then the communication device 230 precludes a configuration of a client application 250; for example, displays a notice indicating that the identification data for the user was not authenticated, or that the user was authenticated but is not authorized to have the client application 250 installed or have a pre-existing client application 250 configured.

Components encompassed in the client application 250, comprising:
1. history recorder 251—structured to record web browsing history with respect to time in the communication device 230 memory (controller 240 memory 242, or controller 240.8 memory 242.8), for each of a sequence of web pages browsed by the client application 250 as web browser, and other web browsers imbedded in the communication device 230;
2. client manager 252—configured to export through the exporter 254 the stored web browsing history and communication device 230 memory stored information to another communicatively linked device, and import through the importer 253 information including ascertainer 108 sent messages;
3. importer 253—for importing web browsing history with respect to time each of a sequence of web pages browsed by other communication device 230 imbedded web browsers; and, messages sent by ascertainer 108, or another communicatively linked communication device 230;
4. exporter 254—for exporting data and information to the ascertainer 108, comprising information pertaining to communication device 230 and client application 250, web browsing history of the client application 250 as a web browser, and other communication device 230 imbedded web browsers.

In an alternative embodiment, client application 250 is a web based service; once activated, a web page provides those functions of the client application 250 (as mentioned above). In general, client application 250 can be any software, program, application, app imbedded in any processor mounted communication device 230 having a graphical user interface, or a web based URL (as discussed further below) executing the aforementioned functionality when visited by the communication device 230 (such as the mobility 183 or computing device 189) via the Internet.

With reference to FIG. 2B, controller 240—possessing short-range wireless linkage capability with telematics functionality—comprises processor 241, memory 242, network interface 243, display & input/output (“I/O”) 244, geo-receiver 245 and wireless data network device 246. Processor 241 is communicatively coupled to a computer-readable storage medium memory 242. Memory 242 may have stored thereon one or more executable programs of instructions that, when executed by the processor 241, performs at least some of the operations of the controller 240, history recorder 251, as well client manager 252. Network interface 243 may include its own memory storing its identifier, and a transceiver to exchange network communications utilizing a short-range wireless protocol such as ultrawideband (UWB), Bluetooth™, IEEE 802.15 or IEEE 802.11. Geo-receiver 245 receives geo-location system 133 (FIG. 1) signals that are processed by the processor 241 for obtainment of geo-location data 336 (FIG. 3). Wireless data network device 246—sometimes known as a transceiver, transceiving device, or network interface card (NIC)—includes circuitry for coupling communication device 230 to one or more networks, and is constructed for use with one or more communication protocols and technologies including, not limited to CDMA, general packet radio service (GPRS), global system for mobile communication (GSM), time division multiple access (TDMA), transmission control protocol/Internet protocol (TCP/IP), user datagram protocol (UDP), SIP/RTP, SMS, ultra wide band (UWB), WAP, IEEE 802.16 Worldwide Interoperability for Microwave Access (WiMax), or any of a variety of other wireless communication protocols.

In FIG. 2C, controller 240.8—with short-range wireless linkage capability, without telematics functionality—comprises components akin to those of controller 240 in FIG. 2B, comprising: processor 241.8, memory 242.8, network interface 243.8, display & I/O 244.8.

FIG. 3 depicts a communication system operation in an environment 300 in conjunction with FIGS. 1-2C, according to an exemplary embodiment. AP 107 with identifier 312 00:14:78:EE:19:F8—communicatively linked to the network 109—relays different networks and sets a route as a router (in compliance with wireless protocol IEEE 802.11, as an example) to provide communication within at least one sub-network between one or more mobilities 183 and computing devices 189 through a short-range wireless linkage 319, and access to network 109 (such as the Internet, as an example) via a data exchanger such as a DSL modem by using IP addresses 311 in allocation in one example: WAN IP 160.13.19.17 for the network 109, LAN IP 192.160.0.1 for the linkage 319, and the linked devices IP addresses 313 (respectively 192.168.0.103, 192.168.0.109) to mobility 183 and computing device 189. AP 107 may uniquely identify itself through any of an identifier that includes a code, device identifier, MAC address, or password.

Short-range wireless linkage 319 is a wireless communicative channel between mobility 183 and computing device 189, via AP 107, to link to network 109 and any processor mounted communication device, receiving, storing and sending information, using any of a variety of application layer protocols of the OSI layered protocol, including but not limited to HTTP, SMTP, RTP/SIP, FTP, or the like, as well as using a variety of transport layer protocols of the OSI layered protocol, for example, including but not limited to, Stream Control Transmission Protocol (SCTP), Transmission Control Protocol (TCP), User Datagram Protocol (UDP), or the like. Linkage 319 may, for example, comprise radio links implemented using a protocol such as IEEE 802.11.

Mobility 183 with identifier 332 00:0F:66:0C:64:40 obtains an AP 107 allocated subnet IP address 331 192.168.0.103, and communicatively links with network 109 through linkage 319; mobility 183 proximity data comprises: subnet IP address 331, AP IP addresses 333 (IP addresses 311), AP identifier 334 (identifier 312), communicatively linked AP linked devices IP address and identifier 335 192.168.0.109 and bc50b27a, and geo-location data 336; whereas, proximity log 337 is “proximate”, indicating mobility 183 is communicatively paired with AP 107.

Computing device 189 with identifier 392 bc50b27a obtains an AP 107 allocated subnet IP address 391 192.168.0.109, and communicatively links with network 109 through linkage 319; computing device 189 proximity data comprises: subnet IP address 391, AP IP addresses 393 (IP addresses 311), AP identifier 394 (identifier 312), communicatively linked AP linked devices IP address and identifier 395 192.168.0.103 and 00:0F:66:0C:64:40; whereas, proximity log 396 is “proximate”, indicating computing device 189 is communicatively paired with AP 107.

The unique identifier identifies a device in distinction, including AP 107, mobility 183, and computing device 189, through an imbedded client application 250, user password, user characteristics, MAC address, or any number comprising digits and letters combining one or more of the preceding identifiers thereof. Mobility 183 may include additional information in the unique identifier, comprising the phone number, Mobile Identification Number (MIN), and other mobility identifier. The unique identifier may be included in a message and sent by a mobility 183, computing device 189, to the ascertainer 108, other communication devices 230, or the like.

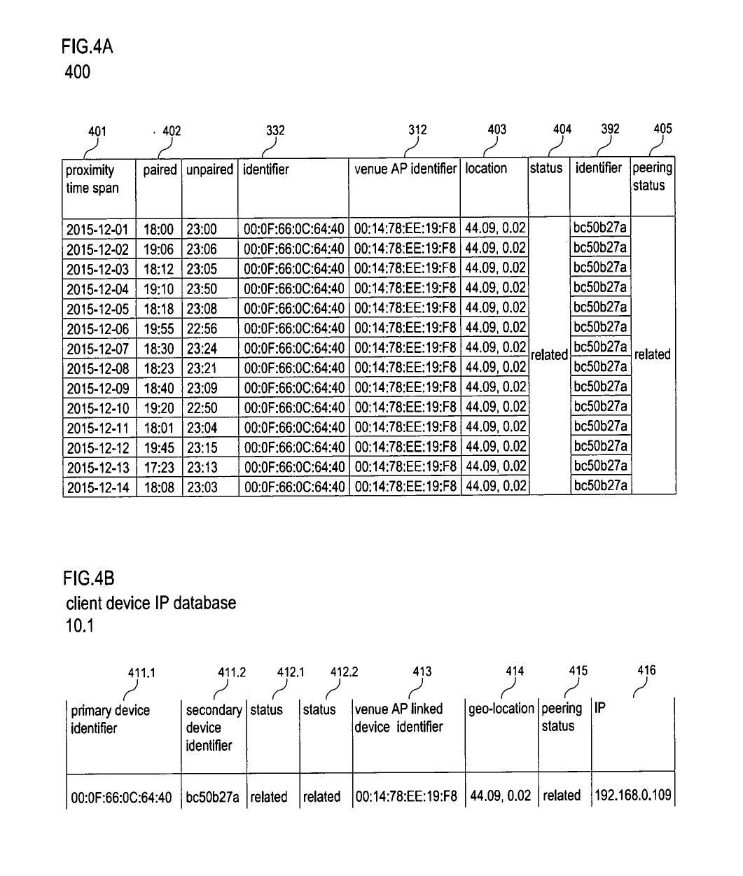

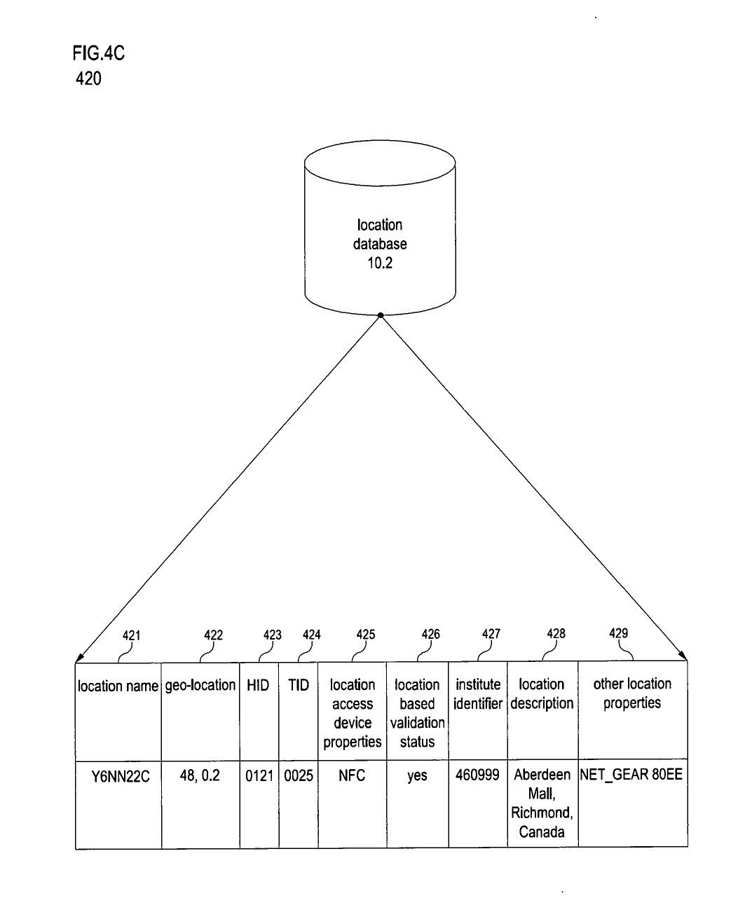

FIG. 4A depicts in conjunction with FIGS. 1, 2B, 3, ascertainer 108 associates mobility 183 (comprising controller 240, with telematics functionality), with authorized use of an account (membership account issued by facilitator 103 as membership, credit card, debit card, as examples), through registration of a mobility 183 identifier (phone number, as an example) with information of the mobility 183 account (number or safe account info, as examples). Ascertainer 108 acknowledges mobility 183 as environment 300 venue related in an exemplary embodiment, in accordance with an ascertainer 108 recorded data storage medium 122 stored venue relationship centric database 400, and, computing device 189 (comprising controller 240.8, without telematics functionality) as peering related to mobility 183, comprising:
proximity time span 401: commencing on Dec. 1, 2015, ending on Dec. 14, 2015;
pairing span 402: identifier 332 00:0F:66:0C:64:40 pertinent mobility 183 regularly paired with environment 300 venue related disposed AP 107, with identifier 312 00:14:78:EE:19:F8, beyond a second threshold (10 pairing numerations and 50 hours of pairing during a fortnight, as an example)—ascertainer 108 obtains pairing span 402 data transported by AP 107 or mobility 183; identifier 392 bc50b27a pertinent computing device 189 regularly paired with environment 300 venue related disposed AP 107, with identifier 312 00:14:78:EE:19:F8, beyond the second threshold—ascertainer 108 obtains pairing span 402 data transported by AP 107, or computing device 189;
location 403: coordinates in mobility 183 sent geo-location data 336—attributing to difference in distance from an ascertainer 108 recorded address or venue (not shown) of an account (credit card account issued by a bank, as an example), pertaining to mobility 183, within a proximity threshold;
status 404: “related” indicating ascertainer 108 acknowledges mobility 183 as environment 300 venue related, and permits to undertake mobility 183 account information base user validation process;
peering status 405: “related” indicating ascertainer 108 acknowledges computing device 189 as environment 300 venue related, peering related to mobility 183, and permits to undertake mobility 183 account information base user validation process.

FIG. 4B depicts in conjunction with FIGS. 1, 2C-4A, an exemplary embodiment of an ascertainer 108 acknowledging a device as mobility 183 peering related in peering relationship centric client device IP database 10.1 stored in data storage medium 122 database 410, which may be stored in the mobility 183 pertinent controller 240 memory 242 (operating as data storage medium 122), comprising:
primary device identifier 411.1: ascertainer 108 acknowledged venue related device identifier—for example, identifier 332 00:0F:66:0C:64:40 of environment 300 venue related mobility 183; there may be a plurality of primary devices identifiers 411.1.n of venue related mobilities 183;
secondary device identifier 411.2: ascertainer 108 acknowledged primary device peering related device identifier—for example, identifier 392 bc50b27a of environment 300 venue related mobility 183 peering related computing device 189; there may be a plurality of secondary devices identifiers 411.2.n of venue related computing devices 189;
status 412.1; “related” indicating primary device identifier 411.1 pertinent device is ascertainer 108 acknowledged as venue related to an environment;
status 412.2: “related” indicating secondary device identifier 411.2 pertinent device is ascertainer 108 acknowledged as venue related to the environment;
AP identifier 413: ascertainer 108 acknowledged environment venue related AP identifier—for example, identifier 334 00:14:78:EE:19:F8 of the venue related environment 300 disposed AP 107;
location 414: an environment being venue related to primary device identifier 411.1 pertinent device and secondary device identifier 411.2 pertinent device—for example, environment 300 at a geo-location with coordinates 44.09, 0.02;
peering status 415: “related” indicating secondary device identifier 411.2 pertinent device is ascertainer 108 acknowledged as peering related to the primary device identifier 411.1 pertinent device, and permitted to undertake an operation of an account of a primary device identifier 411.1 pertinent device;
IP address 416: effective secondary device identifier 411.2 pertinent device IP address (192.168.0.109 of computing device 189, as an example).

FIG. 4C depicts in conjunction with FIGS. 1, 2A, 3, 5A, an exemplary embodiment of an ascertainer 108 recorded data storage medium 122 stored host proximity data storage structure 420 of location database 10.2, comprising:
1. effective proximity data of tracked mobilities 183;
2. effective proximity data and most up-to-date descriptive information of a plurality of hosts 105 with different physical locations.

Location database 10.2 may be configured to store some or all proximity data associated with various hosts 105, data identifying hosts 105 operated incumbent user validation process pertinent access devices 185, comprising:
location name 421: consisting of the name or other identifier (e.g. Y6NN22C) of a host 105 location operating the access device 185;
geo-location 422: (e.g. GPS coordinates 48, 0.2), or any other information suitable to identify the location of host 105 operating the access device 185 including an address, city, state, postal code (such as a ZIP™ code), country;
HID 423: host identifier (e.g. 0121), or a Host Category Code (“HCC”) fora host 105 associated with the access device 185;
TID 424: unique identifier (e.g. 0025) associated with the access device 185 assigned by the corresponding manufacture, or any other party;
location access device properties 425: properties or description of protocols, technologies, manufacturer, of the access device(s) 185 located ata host 105;
location based validation status 426: indicating whether or not a user validation process may be performed in accordance with a host 105 location;
institute identifier 427: unique identifier (e.g. 460999) of an issuer 104, or, facilitator 103 associated with host 105 operating the access device 185;
location description 428: comprising a text string description (e.g. Aberdeen Mall, Richmond, Canada) of a location associated with the access device 185;
other location properties 429: including any information associated with the location not previously mentioned, as an example, a network identifier 501 “NET_GEAR80EE” indicating an available on-site AP 107 providing network linkage, including the Internet, through short-range wireless pairing.

In some instances, location database 10.2 may be queried directly by the consumers by information, such as, name of the location, longitude and latitude coordinates, a zip code or address (e.g., entering data into a web browser or client application 250), or the data could be automatically generated by an integrated location detector (e.g., a GPS program on a mobility or through use of an IP address). The consumer's current location can then be compared against in the location database 10.2 stored location data, and enable consumers to identify location based user validation process abled access devices 185 and the corresponding hosts 105.

In some embodiments, to enable customers with mobilities 183 and computing devices 189 to find nearby locations where user validation process associated access devices 185 are provided, system and methods may be provided to enable facilitators 103, issuers 104, hosts 105, to use a generic locator capable to upload locations, or any other desired mobility data or proximity data into the location database 10.2, as examples, including but are not limited to:
facilitators 103 pertinent hosts 105: restaurants, stores and shops;
issuers 104 pertinent hosts 105: ATM (automatic teller machine) locations, bank locations, prepaid payment device purchase locations, houses, apartments and commercial buildings, hotels and lodging facilities, and automobiles.

FIG. 5A depicts in conjunction with FIG. 3, venue AP list 500 comprising network identifier 501 “NET_GEAR80EE”, and network identifier 502 “NET_GEAR90EE”, pertaining to environment 300 installed APs 107 available for providing pairing for one or more mobiles devices 183 or computing devices 189 to access network 109 via short-range wireless linkage 319.

With reference to FIG. 5B in conjunction with FIGS. 2A-2C, consider mobility 183 enacted web browsing history 510 of browsed web pages is stored in the communication device 230 memory—controller 240 memory 242, or controller 240.8 memory 242.8; each element of the web browsing history 510 may be a data structure having individual fields 511-516, comprising:
thumbnail image 511 for the browsed web page;
group 512 with which the web page is associated;
universal resource indicator (“URI”) 513 of the browsed web page;
date and time 514 at which the browsing of the web page occurred;
preceding web page 515 browsed or accessed immediately prior to the web page corresponding to web browsing history 510 by a web browser;
subsequent web page 516 browsed or accessed immediately after the web page corresponding to the web browsing history 510 by a web browser; wherein the web browsing history 510 corresponds to the most recently browsed web page, the subsequent web page 516 may be null.

A “Universal Resource Indicator” (URI) is the generic name for a “Uniform Resource Locator” (URL) or a “Uniform Resource Name” (URN). In furtherance, a preceding web page 515 and subsequent web page 516 fields may be pointers to other web browsing history 510 elements which correspond to the preceding web page 515 and subsequent web page 516.

Referring to FIG. 5C in conjunction with FIGS. 1-2C, mobilities 183 is configured to obtain geo-location data positions d₁-d₅ on the basis of location signals received from geo-location system 133; ascertainer 108 receives mobility 183 (comprising controller 240) sent proximity data, positions d₁-d₅ and venue AP lists I₁-I₅ recorded at instantaneous times t₁-t₅, attributes to a time based user blockchains path 520, comprising:

TABLE 2
[mobility 183 pertinent proximity data]

| Instantaneous time tₙ | Position dₙ (GPS coordinates) | venue AP list lₙ |
|---|---|---|
| t₁ at 9:00.00 | d₁ 45, 0 | l₁ |
| t₂ at 10:00.00 | d₂ 44.08, 0.02 | l₂ |
| t₃ at 11:00.00 | d₃ 44.06, 0.03 | l₃ |
| t₄ at 12:00.00 | d₄ 44.04, 0.07 | l₄ |
| t₅ at 13:00.00 | d₅ 44.02, 0.08 | l₅ |

On the other hand, user blockchains path 520 of a computing device 189 (comprising controller 240.8) includes a venue AP list comprising Iₙ, recorded with respect to instantaneous time tₙ, yet excluding the positions dₙ.

The user blockchains path 520 pertinent proximity data—positions dₙ, venue AP lists Iₙ, recorded at instantaneous times tₙ by mobility 183—is stored in the controller 240 memory 242 (operating as data storage medium 122), and sent to ascertainer 108 in accordance with preconfigured operating parameters, or, as response information to ascertainer 108 prompted requests. Ascertainer 108 stores the user blockchains path 520 in data storage medium 122—which is a memory entity other than the mobility 183 controller 240 memory 242.

In an exemplary user validation process, a host 105 pertinent validation request message 110 encompassing validation time tᵥ “11:30 a.m.” and a concurrent position dᵥ is received by ascertainer 108, which ascertains the validation velocity vᵥ with a proximity threshold, by extrapolating position d₃—the most recently obtained mobility 183 pertinent user blockchains path 520—in accordance with an average traversal velocity v, comprising:

$$v = \frac{( {d}_{3} - {d}_{1} )}{( {t}_{3} - {t}_{1} )} \qquad [ 1 ]$$

substituting the change from position d₃ to position dᵥ, over the lead time period Δtₗ (comprising the time difference between t₃ and tᵥ) with equation [1], position dᵥ is within a proximity threshold: ascertainer 108 concludes that position dᵥ conforms with user blockchains path 520 in a change of location from position d₃ to the validation time tᵥ pertinent position dᵥ with respect to the lead time period Δtₗ: ascertainer 108 deems the validation request message 110 pertinent user validation process “valid” (as discussed further below).

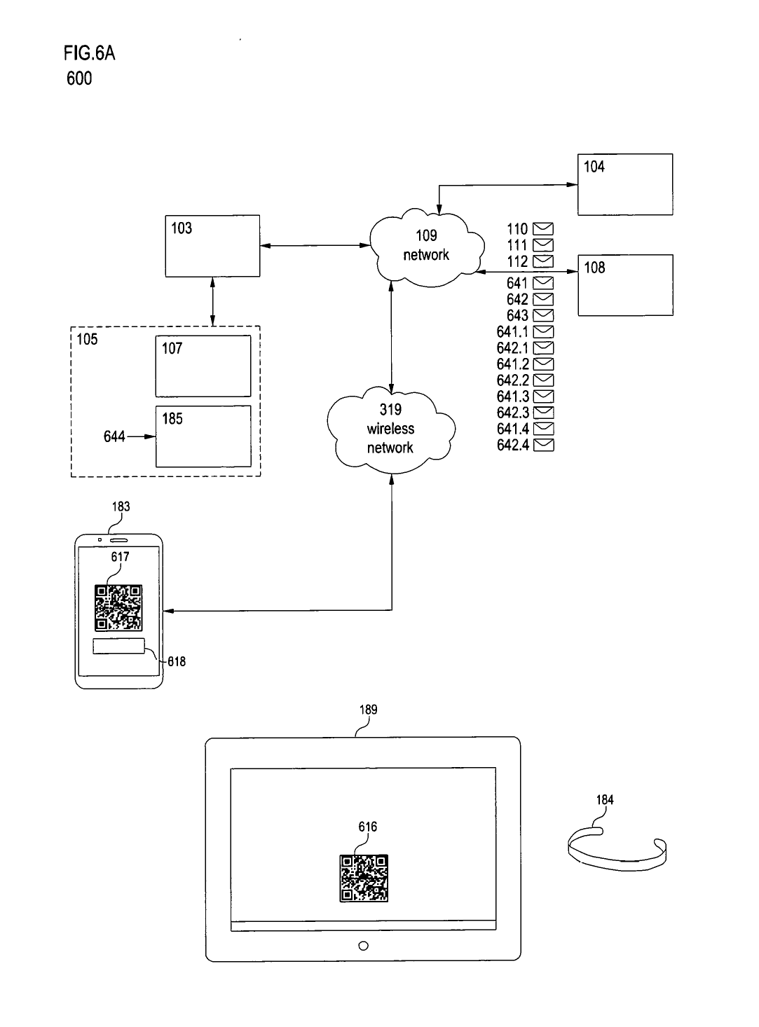

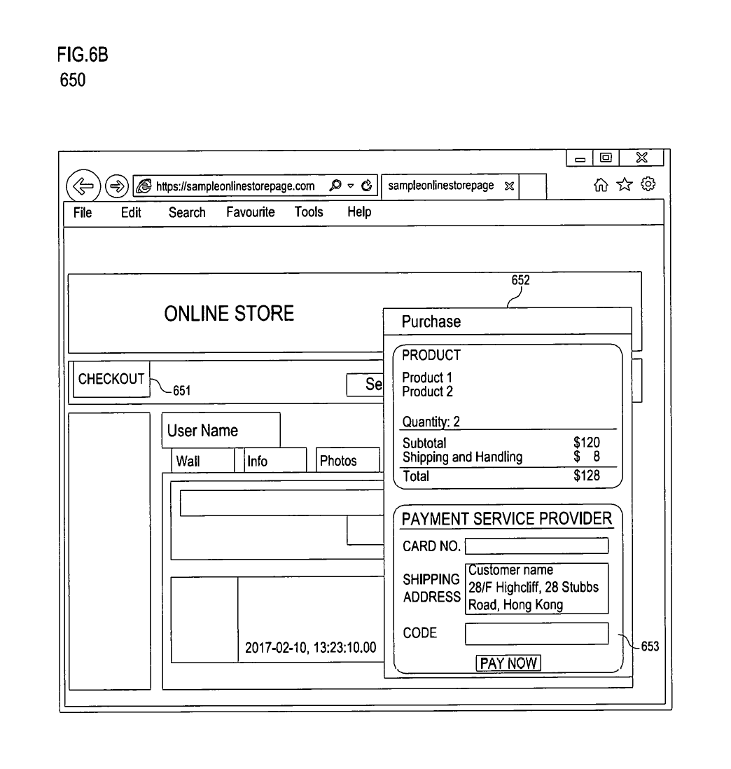

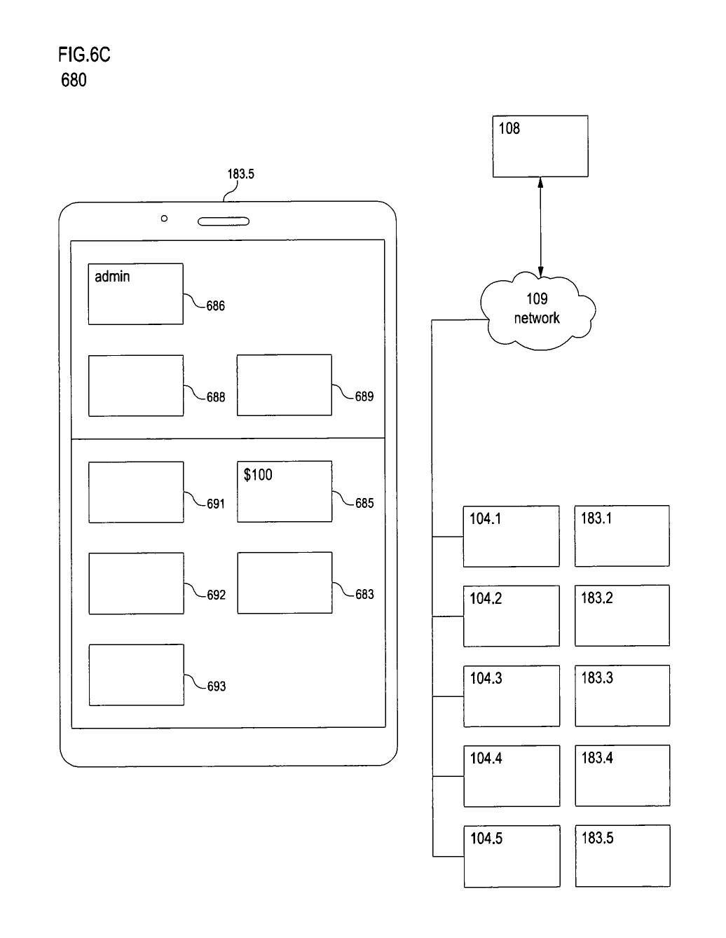

FIG. 6A illustrates a setting 600 in conjunction with FIGS. 1, 2A, 3, 4B: ascertainer 108 is configured to acknowledge and record venue related mobility 183 and peering related computing device 189 in the client device IP database 10.1. Computing device 189 displays a client application 250 generated quick response (QR) code 616—comprising information such as identifier 392 bc50b27a or other identifying code as an example. In one embodiment, ascertainer 108 ascertains computing device 189 as peering related to a client application 250 imbedded mobility 183, comprising:
mobility 183 capturing QR code 616;
mobility 183 localizing an area of the QR code 616 by combining criteria determination to identify the QR code 616, where the criteria comprise pixel dynamic scale (DS), black-cell ratio (BR), and edge intensity sum (EIS)—performed by mobility 183 or ascertainer 108.

Ascertainer 108 records the mobility 183 sent QR code 616, acknowledging computing device 189 as peering related to mobility 183, is permitted to process online user validation process comprising mobility 183 account information. In another embodiment, mobility 183 displays a client application 250 generated payment QR 617 and string code 618—which will be discussed below.

Similarly in a further embodiment, a printed QR code (not shown) comprising an identification means 684 unique identifier can be scanned by the mobility 183, for sending to ascertainer 108, which acknowledges and records the identification means 684 as peering related to the mobility 183 in a database; wherein computing device 189 is permitted to process online user validation process comprising mobility 183 account information, providing that the computing device 189 and identification means 684 are within a distance that does not exceed the proximity threshold.

FIG. 6B illustrates a website 650 in conjunction with FIG. 6A pertaining to an online store merchant 105—which will be discussed below.

FIG. 6C depicts a communications group 680 for online fiscal transfer.

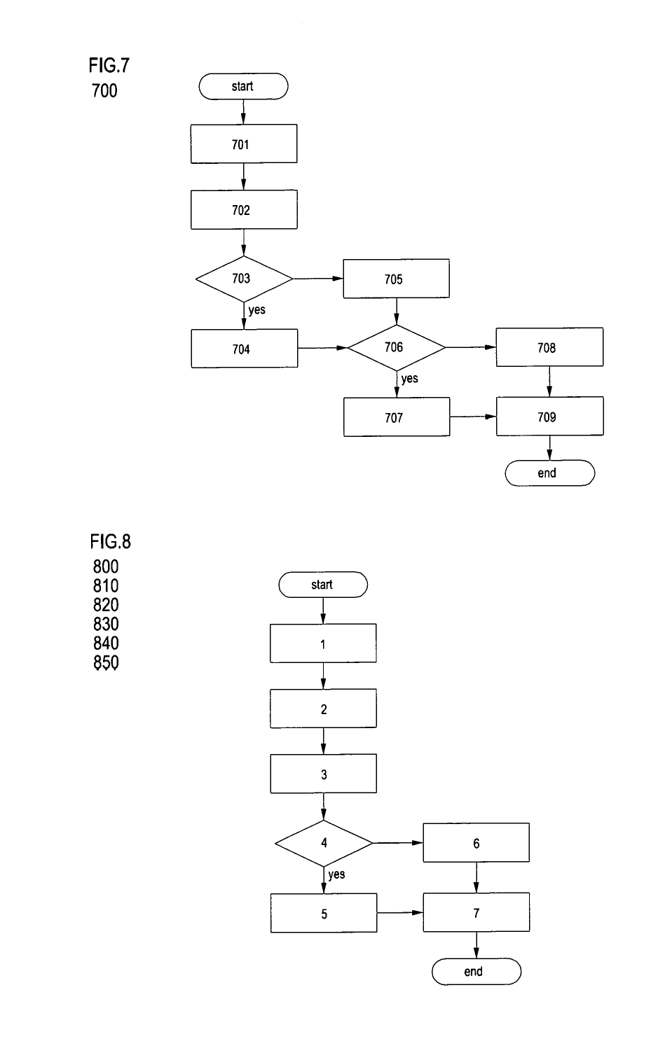

FIG. 7 presents a flow diagram of an online user validation process 700 in conjunction with FIGS. 2A-2C, 3, 4B, 5B, 6A, and 6B. Processing logic resides in a few entities and apparatuses as discussed hereinafter.

At block 701, mobility 183 (comprising controller 240, with telematics functionality) is communicatively linked with network 109; computing device 189 (comprising controller 240.8, without telematics functionality) is communicatively linked with network 109 by obtaining an IP address allocated by a communicatively paired AP 107 via short-range wireless linkage 319. A customer, using an account (issuer 104 as a financial institute issued credit card, commercial institute issued debit card, as examples) associated mobility 183 and mobility 183 peering related computing device 189, pays for a purchase transaction from a merchant 105 online store website 650. Website 650 then displays a form 652 requesting entry of mobility 483 account information in icon 653 (account information or account pertinent issuer 104 issued code)—the customer settles the transaction through payment with the mobility 183 account by entering information of mobility 183 account in icon 653, and clicking on a checkout iconic button 651, as indication of intention of credit transfer at validation time tᵥ. The host 105 operating website 650 seeks payment from the mobility 183 associated account (“online operation”).

At block 702, ascertainer 108 receives an issuer 104 issued mobility 183 account (payment card, credit card, issued by a bank or financial institute, as examples) and merchant 105 pertinent validation request message 110—generated and sent by any one of merchant 105 pertinent acquirer 103, issuer 104, merchant 105, a mobility 183 account pertinent payment network (not shown), or client application 250 upon detecting entry of mobility 183 account information—comprising selected information of the acquirer 103 issued merchant 105 account, name and identifier of issuer 104, mobility 183 account information (number or safe account info, as examples) of mobility 183 account. Ascertainer 108 acknowledges the validation request message 110 as request for verification of relevance of a validation time tᵥ based merchant 105 pivotal online operation to the mobility 183 account, and performs the online user validation process.

At block 703, ascertainer 108 seeks the effective computing device 189 IP address 416 from the data storage medium 122 stored client device IP database 10.1—in one embodiment, computing device 189 imbedded client application 250 exports through exporter 254 to ascertainer 108 the proximity data, comprising computing device 189 pertinent secondary device identifier 411.2 and IP address 416 upon detecting entry of selected information of the mobility 183 account in a browsed website 650; in another embodiment, mobility 183 imbedded client application 250 obtains and sends to ascertainer 108 secondary device identifier 411.2 and IP address 416 of computing device 189 upon detecting computing device 189 through short-range wireless linkage 319; alternatively, a peering process is executed by the computing device 189 (comprising controller 240.8) imbedded with client application 250, which has ascertained that the computing device 189 has no telematics functionality, comprising:
establishing pairing with the gateway 107 via a short-range wireless communicative linkage 319;
obtaining IP address 416—allocated by gateway 107;
obtaining venue router IP addresses from the gateway 107 and recording in the computing device 189 memory 242.8;
retrieving identifier 00:0F:66:0C:64:40 of the peering related user mobile device 183 from the memory 342.8;
exporting the IP address 416, identifier 392 through the exporter 254;
broadcasting the computing device 189 proximity data, comprising the IP address 416, identifier 392, venue router IP addresses 393, and venue router identifier 394, through the gateway 107, for receiving by the user mobile device 183 as a user related peering device; or sending the proximity data to the ascertainer 108. Wherein, the broadcasted proximity data may be processed in accordance with the protocols TCP, UDP, or the like. In an alternative embodiment, an incumbent client application 250 prompts the computing device 189 to unicast its proximity data through the gateway 107, for receiving by the user mobile device 183 as a user related peering device.

At block 704, ascertainer 108 successfully obtains the effective IP address 416 from client device IP database 10.1, and requests mobility data from computing device 189 in message 641 sent through network 109. In response to message 641 imported by importer 253 of the imbedded client application 250, computing device 189 sends through network 109 to ascertainer 108 a response message 642—comprising client manager 252 retrieved time based computing device 189 web browsing history 510 recorded with respect to time in the controller 240.8 memory 242.8 within a time period encompassing the validation time tᵥ.

Alternatively at block 705, ascertainer 108 fails to obtain the effective IP address 416, and requests mobility data from mobility 183 in message 641 sent through network 109. In response to message 641, mobility 183 sends through network 109 to ascertainer 108 a response message 642—comprising client manager 252 retrieved time based mobility 183 web browsing history 510 recorded with respect to time in the controller 240 memory 242 within a time threshold from the validation time tᵥ.

At block 706, ascertainer 108 performs the user validation process by validating the relevance of the validation request message 110 pertinent online operation entailed web portal to response message 642 encompassed web browsing history 510.

At block 707, as acknowledgment of relevance of the online operation to mobility 183 account, ascertainer 108 concludes the user validation process with a status indicator “valid”, comprising:
response message 642 encompassed web browsing history 510 demonstrating relevance—URI 513 recorded at date and time 514 encompassing the validation time tᵥ, at which the browsed one or more of the web pages include the online store merchant 105 website 650 as entailed to perform the validation request message 110 pertinent online operation.

In contrary at block 708, ascertainer 108 concludes the online user validation process with a status indicator “invalid”, comprising:
URI 513 recorded at date and time 514 encompassing the validation time tᵥ, at which the browsed one or more of the web pages are not relevant to the validation request message 110 pertinent online operation; or,
response message 642 is not received by ascertainer 108.

At block 709, ascertainer 108 sends through network 109 an outcome 643—message encompassing a status indicator “valid”, or, a status indicator “invalid”, to receiving nodes, comprising one or more of the following:
acquirer 103;
issuer 104;
merchant 105;
mobility 183;
mobility 183 account pertinent payment network (not shown) clearing and settlement services payment authorization services (such as the MasterCard® payment card system interchange network, or VisaNet™, or any government pertinent institutes, as examples).

The receiving nodes pertaining to acquirer 103, issuer 104, merchant 105, payment network, may comprise code driven processor and memory mounted application server or control system, as examples. As an option, outcome 643 may include an alert with a status indicator “invalid”.

The online operation may comprise any fiscal transaction entailing transfer of amount of settlement from a mobility 183 bank account, or a mobility 183 account pertaining to issuer 104 and payment network, to a merchant 105 account through a web portal.

FIG. 8 presents a flow diagram of a user validation process 800 in conjunction with FIGS. 2A-3, 4C, 5A, and 6A. Processing logic resides in a few entities and apparatuses as discussed hereinafter.

Process 800 commences at block 1: ascertainer 108 associates a mobility 183 (comprising controller 240) and an issuer 104 issued account (payment card, credit card, issued by a bank or financial institute, as examples) through storing in the data storage medium 122 a mobility 183 identifier (phone number, as an example) and mobility 183 account information (number or safe account info, as examples).

At block 2, access device 185 performs at a validation time tᵥ, host 105 pivotal, operation (“transaction”) pertaining to the mobility 183 account—access device 185 sends the pertinent information to any one or combination of receiving nodes, comprising: issuer 104—which issued mobility 183 account, host 105 operating access device 185, host 105 pertinent facilitator 103 (a bank or financial institute, as examples), and a mobility 183 account pertinent payment network (not shown). Ascertainer 108 receives—issuer 104 issued mobility 183 account and transaction—pertinent validation request message 110—generated and sent by any one of host 105 pertinent facilitator 103, issuer 104, host 105, host 105 pertinent access device 185, or mobility 183 account pertinent payment network (not shown)—comprising selected information of any one or combination of: facilitator 103 issued host 105 account, issuer 104 identifier, mobility 183 account. Ascertainer 108 acknowledges validation request message 110 as request for validation of relevance of the transaction to mobility 183 account.

At block 3, in one embodiment, validation request message 110 comprises access device 185 identifier, IP address, and in an option the proximity data. In another embodiment, ascertainer 108 requests “proximity data” from mobility 183 via a message 641.1 sent through network 109, mobility 183 sends through network 109 to ascertainer 108 a response message 642.1 comprising its proximity data; ascertainer 108 sends to access device 185 message 641.2—comprising selected or all information of response message 642.1 comprised mobility 183 proximity data. Alternatively, ascertainer 108 requests “proximity data” from access device 185 via a message 641.3 sent through network 109; access device 185 sends through network 109 to ascertainer 108 a response message 642.3 comprising its proximity data; ascertainer 108 sends to mobility 183 message 641.4—comprising selected or all information of response message 642.3 comprised access device 185 proximity data.

Mobility 183 proximity data, comprising any one or combination of:
present position dₙ of mobility 183 obtained in response to message 641.1;
one or more positions dₙ of the controller 240 memory 242 stored user blockchains path 520 recorded with respect to time in controller 240 memory 242 within a time threshold from the validation time tᵥ;
present venue AP list 500 of detected APs 107 available for providing short-range wireless communicative linkage to mobility 183;
venue AP list 500 recorded with respect to time in a memory within a time threshold from the validation time tᵥ;
proximity log 337.

Access device 185 proximity data, comprising any one or combination of:
present geo-location (“transaction location dᵥ”) obtained at a time within a time threshold from validation time tᵥ, or validation time tᵥ—access device 185 is configured to receive geo-location system 133 sent signals and calculate the pertinent geo-location data;
transaction location dᵥ—user entered and memory stored;
venue AP list 500 recorded with respect to time in a memory within a time threshold from the validation time tᵥ;
identifier 501 “NET_GEAR80EE” of access device 185 equipped AP 107.

At block 4, either ascertainer 108, or mobility 183, or access device 185, performs the user validation process by validating the relevance of the mobility 183 proximity data to access device 185 proximity data, comprising any one or combination of the following:
determining whether the distance between the transaction location dᵥ and mobility 183 position dₙ recorded at a time within a time threshold from validation time tᵥ, is within or exceeds proximity threshold 525;
validating the relevance of mobility 183 pertinent venue AP list 500 to access device 185 pertinent venue AP list 500;
validating the relevance of the mobility 183 obtained present venue AP list 500, to access device 185 pertinent identifier 501 “NET_GEAR80EE”;
determining whether proximity log 337 is “proximate”.

At block 5, as acknowledgment of relevance of the transaction to mobility 183 account, either ascertainer 108, or mobility 183, or access device 185, concludes the user validation process with a status indicator “valid”, comprising any one or combination of the following:
distance between the transaction location dᵥ and mobility 183 position d₄ (as an example) recorded at a time within a time threshold from validation time tᵥ, is within proximity threshold 525;
ascertained relevance of mobility 183 pertinent venue AP list 500 to access device 185 pertinent venue AP list 500—both comprising at least one AP 107 identifier in commonality;
mobility 183 pertinent venue AP list 500 comprising identifier 501 “NET_GEAR80EE” of access device 185 equipped AP 107;
proximity log 337 as “proximate”—mobility 183 is communicatively paired with access device 185 equipped AP 107.

In contrary at block 6, either ascertainer 108, or mobility 183, or access device 185, concludes the user validation process with a status indicator “invalid”, comprising any one of the following:
distance between the transaction location dᵥ and mobility 183 position d₈ (as an example) recorded at a time within a time threshold from validation time tᵥ, exceeds proximity threshold 525;
mobility 183 pertinent venue AP list 500 is irrelevant to access device 185 pertinent venue AP list 500—without any AP 107 identifier in commonality;
identifier 501 “NET_GEAR80EE” of access device 185 equipped AP 107 is unavailable in mobility 183 pertinent venue AP list 500;
proximity log 337 is not “proximate”—mobility 183 is not communicatively paired with access device 185 equipped AP 107.

In the event that access device 185 performs the user validation process, access device 185 sends through network 109 to ascertainer 108 a response message 642.2 comprising a status indicator “valid”, or, a status indicator “invalid”. In the event that mobility 183 performs the user validation process, mobility 183 sends through network 109 to ascertainer 108 a response message 642.4 comprising a status indicator “valid”, or, a status indicator “invalid”: ascertainer 108 concludes the user validation process with a status indicator “invalid”, when receiving multiple response messages 642.1 or response messages 642.4; or, not receiving response messages 642.1, 642.4.

At block 7, ascertainer 108 sends through network 109 an outcome 643—encompassing a status indicator “valid”, or, a status indicator “invalid”, to receiving nodes, comprising one or more of the following:
facilitator 103;
issuer 104;
host 105;
mobility 183 (in the event that ascertainer 108, or access device 185, performs the user validation process);
access device 185 (in the event that ascertainer 108, or mobility 183, performs the user validation process);
mobility 183 account pertinent payment network.

The receiving nodes pertaining to facilitator 103, issuer 104, host 105, payment network, may comprise code driven processor and memory mounted application server or control system, as examples. As an option, outcome 643 may include an alert with a status indicator “invalid”. Whereas, transaction may comprise payment with mobility 183 account to a bank account of host 105 as merchant through access device 185 as point-of-sale terminal (“POS terminal”); or, cash withdrawal through access device 185 as automated teller machine (“ATM”) of host 105 as bank, as examples. Access device 185 at transaction location dᵥ performs the validation time tᵥ based mobility 183 account pertinent transaction in accordance with a status indicator “valid”; or, access device 185 rejects the mobility 183 account pertinent transaction in accordance with status indicator “invalid”, in an option, triggers an alert.

FIG. 8 presents a flow diagram of an embodiment in variation of process 810 in conjunction with FIGS. 2A, 2B, and 6A. Processing logic resides in a few entities and apparatuses as discussed hereinafter.

At block 1, a host 105 pertinent computing device 189 generates (as an example, with an imbedded client application 250) QR code 616, encompassing information of facilitator 103 issued host 105 account, and credit of settlement ($100.00 in a currency, as an example) to be deposited into a host 105 account. QR code 616 may also encompass an effective IP address, and identifier (host 105 HCC/HID, unique identifier of computing device 189, as examples).

Mobility 183 (comprising controller 240) obtains QR code 616 and therefore the encompassed information through optical scanning or data transmission via NFC, via network 109 or short-range wireless linkage 319. Part or all of the received QR code 616 encompassed information is selectively displayed by the mobility 183 display & I/O 244. Mobility 183 sends to issuer 104 an imbedded client application 250 generated request message 111 with respect to validation time tᵥ, comprising:
issuer 104 issued mobility 183 account information, authorizing transfer credit of settlement from the account to the QR code 616 pertinent host 105 account;
mobility 183 identifier;
recorded validation time tᵥ.

As a possibility, request message 111 may also include mobility 183 pertinent account information, or, biometrics (such as information pertaining to the iris, thumbprint), electronic signature, or password.

At block 2, ascertainer 108 receives a validation request message 110—generated and sent by the issuer 104, mobility 183—comprising selected information of request message 111. Ascertainer 108 acknowledges the validation request message 110 as request for verification of relevance of a validation time tᵥ based mobility 183 account pertinent credit of settlement, and performs the user validation process. Ascertainer 108 requests “mobility data” from mobility 183 via message 641.1 sent through network 109.

At block 3, mobility 183 sends through network 109 to ascertainer 108 a response message 642.1 comprising the mobility data—comprising the record of validation time tᵥ pertinent request message 111. In one possibility, ascertainer 108 sends to mobility 183 the response message 642.1 comprised mobility 183 pertinent mobility data in message 641.2.

At block 4, either ascertainer 108, or mobility 183, performs the user validation process, comprising validating the relevance of mobility 183 sent mobility data to the validation request message 110 encompassed information.

At block 5, as acknowledgment of relevance of the validation request message 110 to mobility 183, ascertainer 108 concludes the user validation process with a status indicator “valid”, comprising the record of request message 111 is inclusive of the mobility 183 mobility data.

In contrary at block 6, either ascertainer 108, or mobility 183, concludes the user validation process with a status indicator “invalid”, comprising:
response message 642.1 encompassing irrelevant information to record of request message 111 in validation request message 110; or,
response message 642.1 is not received by ascertainer 108.

At block 7, ascertainer 108 sends through network 109 an outcome 643—encompassing a status indicator “valid”, or, a status indicator “invalid”, to receiving nodes, comprising one or more of the following:
issuer 104 pertinent receiving node (comprising code driven processor and memory mounted application server or control system, as examples);
mobility 183;
QR code 616 pertinent computing device 189.

In one embodiment, outcome 643 encompasses a blockchains code tagged to each credit of settlement pertinent currency unit ($1.00 as an example) deposited into the host 105 account with traceable information of the mobility 183 account as depositor, comprising (as an example):
($ git clone https://github.com/openchain/docker.git openchain $ cd openchain $ cp templates/server.yml docker-compose.yml, $ mkdir data)

As an option, outcome 643 may include an alert with a status indicator “invalid”. In other embodiments, mobility 183 requested transfer of credit of settlement are in forms of received figures, imaging, etc., and therefore not limited to being encompassed in the QR code 616.

FIG. 8 presents a flow diagram of an online user validation process 820 for credit transfer (cash, digital money, stock equity, as examples) in conjunction with FIGS. 1, 2A, 2B, 6A, and 6B. Processing logic resides in a few entities and apparatuses as discussed hereinafter.

At block 1, mobility 183 (comprising controller 240, with telematics functionality) belonging to a customer is communicatively linked with network 109. In one embodiment, the customer makes a purchase of goods with payment card from a merchant 105 such as checking out at a cashier; alternatively, the customer pays for a purchase transaction from a merchant 105 online store website 650 with payment card by clicking on a checkout iconic button 651, or online transfer of stock equity—providing input as indication of intention of credit transfer using the method described here. Website 650 then displays a form 652 requesting entry of mobility 483 account information pertaining to an account or issuer 104 issued payment card as a code 653.

Mobility 183—preconfigured to, or through an imbedded client application 250—generates and records in memory for archive a payment code, authorizing payment for one purchase transaction and pertaining to information comprising any one or combination of: an encrypted unique code, a validation time tᵥ concurrent to the time of generation of the payment code in sync with the ascertainer 108 application server 134 clock, mobility 183 phone number, purchase transaction sum, mobility 183 pertinent payment card information such as name of the payment card holder, payment card number, the corresponding issuer 104 and payment network, etc. In one embodiment, one account is selected among a plurality of mobility 183 accounts (credit card accounts, bank accounts, payment cards, debit card accounts, as examples), while the payment code is generated as a payment QR 617—which may be obtained (through scanning or RF/network transmission, as examples) by a POS terminal 185 (or a computing device 189), and sent along with the purchase transaction sum and mobility 183 pertinent payment card number to an acquirer 103, or a payment network related to the selected mobility 183 payment card account. Alternatively, the payment code is generated as a string code 618 comprising numeric digits and alphabetical letters—which may be entered as code 653 in the website 650. String code 618 is then sent to a merchant 105 pertinent acquirer 103, or a payment network—in one aspect, a payment request is sent to the payment card issuer 104. The payment QR 617 and string code 618 may, or may not, encompass the mobility 183 payment card number, and time based, or not time based.

In one example, a mobility 183 generates on the basis of an algorithm for obtainment by a POS terminal 185 and records as archive in the memory a payment QR 617, comprising:
validation time tᵥ (e.g. date Feb. 10, 2017, time 15:23:10.00) of payment QR 617 generation—date and time in sync with an ascertainer 108 clock;
+44 (0) 20 8282 8080—mobility 183 phone number;
Adam Smith—name of the payment card holder;
01—issuer 104 code;
VisaNet™—payment network of the payment card.

In another example, a mobility 183 generates on the basis of an algorithm for entry as code 653 to form 652 and records as archive in the memory a string code 618, comprising:
01442082828080abxc2017021015231000—as an example, encompassing purchase transaction sum ($128), validation time tᵥ (date Feb. 10, 2017, time 15:23:10.00), mobility 183 pertinent payment card information such as name of the payment card holder, payment card number, the corresponding payment network. In a further embodiment, mobility 183 sends through network 109 a request message to ascertainer 108 for a code and receives in reply from ascertainer 108 a payment QR 617 or string code 618—which, approval processor 121 of ascertainer 108 is configured to generate.

At block 2, ascertainer 108 receives an issuer 104 issued mobility 183 payment card account and merchant 105 pertinent validation request message 110—generated and sent by any one of merchant 105 pertinent acquirer 103, issuer 104, merchant 105 pertinent POS terminal 185, or a mobility 183 payment card account pertinent payment network—validation request message 110 comprises information of the payment QR 617, or string code 618. Ascertainer 108 acknowledges the validation request message 110 as request for verification of relevance of a validation time tᵥ based merchant 105 pivotal purchase transaction to the mobility 183 payment card account, and performs the user validation process. Ascertainer 108 requests mobility data from mobility 183 via message 641 sent through network 109.

At block 3, in response to message 641, mobility 183 sends through network 109 to ascertainer 108 a response message 642 encompassing the archival mobility data, comprising record of the generated or imported payment QR 617, or, record of the string code 618.

At block 4, ascertainer 108 performs the user validation process by validating the validation request message 110 encompassed information with mobility 183 sent response message 642 encompassed record.

At block 5, as acknowledgment of validity of the validation request message 110 pertinent merchant 105 pivotal purchase transaction charging on the mobility 183 payment card account, ascertainer 108 concludes the user validation process with a status indicator “valid”, comprising:
response message 642 encompassing record of the payment QR 617; or,
response message 642 encompassing record of the string code 618.

In contrary at block 6, ascertainer 108 concludes the user validation process with a status indicator “invalid”, comprising:
response message 642 not including record of the payment QR 617, or string code 618; or,
response message 642 is not received by ascertainer 108.

At block 7, ascertainer 108 sends through network 109 an outcome 643—encompassing a status indicator “valid”, or, a status indicator “invalid”, to receiving nodes, comprising one or more of the following:
acquirer 103;
issuer 104;
merchant 105;
mobility 183;
POS terminal 185 (or computing device 189);
mobility 183 account pertinent payment network.

The receiving nodes pertaining to facilitator 103, issuer 104, merchant 105, payment network, may comprise code driven processor and memory mounted application server or control system, as examples. As an option, outcome 643 may include an alert with a status indicator “invalid”.

FIG. 8 presents a flow diagram of another embodiment of a process 830 in conjunction with FIGS. 1, 2A-2C, 4B, 4C, 5A, and 6A. Processing logic resides in a few entities and apparatuses as discussed hereinafter.

Process 830 commences at block 1: a venue AP list 500—comprising network identifiers 501 “NET_GEAR80EE”, 502 “NET_GEAR90EE”, pertaining to host 105 pertinent environment 600 installed APs 107 available for providing pairing through short-range wireless linkage 319 to access network 109—is captured and sent, at frequency and time intervals in accordance with preset operating parameters, by one or more of the APs 107, or host 105 operated communication device. Ascertainer 108 receives and stores the venue AP list 500 as venue reference profile in the data storage medium 122.

At block 1: facilitator 103 (landlord, property operator, tenant, as examples) issues an account (ownership account, membership account or rental account with validity throughout a time period, as examples) with authorization to mobility 183 (comprising controller 240) and computing device 189 (comprising controller 240.8) in activation of a state change operation (locked/unlocked, as an example) of an environment 600 disposed short-range wireless linkage 319 linked access device 185; ascertainer 108 associates the mobility 183 and the host 105 disposed access device 185 as peering related, by recording in the data storage medium 122 stored client device IP database 10.1 a mobility 183 identifier (phone number, as an example) and information for authorization of activation of operative state change of access device 185, comprising:
primary device identifier 411.1: identifier of mobility 183;
secondary device identifier 411.2: identifier of computing device 189;
status 412.1: mobility 183 is ascertainer 108 acknowledged, in accordance with a host 105 (hotel, property landlord, property operator, club, as examples) issued mobility 183 account (employee account, tenancy at a hotel, property lease or ownership, membership account of a club providing sports or leisure facilities, with optional validity throughout a time period, as examples), as related to access device 185—there may be a plurality of venue related mobilities 183.n;
status 412.2: computing device 189 is ascertainer 108 acknowledged as related to access device 185, there may be a plurality of computing devices 189.n;
AP identifier 413: identifier of access device 185 communicatively linked environment 600 disposed AP 107;
location 414: geo-location of environment 600, which is ascertainer 108 acknowledged as venue related to access device 185;
peering status 415: “related” indicating computing device 189 is ascertainer 108 acknowledged as peering related to mobility 183, and permitted to undertake an access device 185 state change operation; there may be a plurality of peering related mobilities 183.n, computing devices 189.n;
IP address 416: effective computing device 189 device IP address, if available.

At block 3, mobility 183 communicatively links with ascertainer 108 via pairing with the short-range wireless linkage 319. Mobility 183 sends to ascertainer 108 at a validation time tᵥ an activation request message 112—pertaining to activating an access device 185 state change operation. In an additional embodiment, activation request message 112 also encompasses mobility 183 pertinent proximity data—a venue AP list 500 of the environment 600 is captured and encompassed in the activation request message 112. Ascertainer 108 acknowledges the activation request message 112 as request for verification of relevance of a validation time tᵥ pertinent access device 185 state change operation to mobility 183 account, and performs the user validation process. In an alternative embodiment, ascertainer 108 detects the access device 185 pertinent AP 107 linked short-range wireless linkage 319 paired mobility 183.

Ascertainer 108 further requests proximity data from mobility 183 via message 641 sent through network 109. In response to message 641, mobility 183 sends through network 109 to ascertainer 108 a response message 642 encompassing the pertinent proximity data, comprising one or more of:
mobility 183 identifier;
present venue AP list 500;
present position dₙ of mobility 183;
one or more positions dₙ of the controller 240 memory 242 stored user blockchains path 520 recorded with respect to time in controller 240 memory 242 within a time threshold from the validation time tᵥ.

At block 4, ascertainer 108 performs the user validation process by validating the mobility 183 sent proximity data, comprising:
verifying the identifier of mobility 183 in accordance with the data storage medium 122 stored client device IP database 10.1;
validating the relevance of mobility 183 pertinent venue AP list 500 to the data storage medium 122 stored venue reference profile;
ascertaining the response message 642 encompassed positions dₙ with data storage medium 122 stored mobility 183 user blockchains path 520;
ascertaining the mobility 183 sent validation time tᵥ pertinent geo-location in accordance with the location database 10.2 stored transaction pertinent host 105 geo-location 422 (“operation location”).

At block 5, as acknowledgment of relevance of the activation request message 112 to access device 185 state change operation, ascertainer 108 concludes the user validation process with a status indicator “valid”, comprising one or more of the following:
identifier of mobility 183 registered and effective at the validation time tᵥ in the data storage medium 122 stored client device IP database 10.1;
ascertained relevance of mobility 183 pertinent venue AP list 500 to venue reference profile—both comprising at least one AP 107 identifier in commonality;
response message 642 encompassed positions dₙ existing in the data storage medium 122 stored mobility 183 user blockchains path 520;
distance between the geo-location of environment 600 and mobility 183 position d₄ (as an example) recorded at a time within a time threshold from validation time tᵥ, is within proximity threshold 525.

In contrary at block 6, ascertainer 108 concludes the user validation process with a status indicator “invalid”, comprising any one of the following:
identifier of mobility 183 ineffective at the validation time tᵥ in the data storage medium 122 stored client device IP database 10.1;
identifier of mobility 183 is ineffective at the validation time tᵥ in the data storage medium 122 stored client device IP database 10.1;
irrelevance of mobility 183 pertinent venue AP list 500 to venue reference profile—without AP 107 identifier in commonality;
response message 642 encompassed positions dₙ irrelevant to the data storage medium 122 stored mobility 183 user blockchains path 520;
distance between the geo-location of environment 600 and mobility 183 position d₈ (as an example) recorded at a time within a time threshold from validation time tᵥ, exceeds proximity threshold 525.
response message 642 is not received by ascertainer 108.

At block 7, ascertainer 108 generates and transmits over network 109 an outcome of the user validation process, comprising any one of the following:
status indicator “valid”—approval processor 121 sending through a selected environment 600 installed AP 107 a commanding signal 644 to the access device 185, actuating the operative state from locked to unlocked; wherein, the commanding signal 644 may encompass a code;
status indicator “invalid”—approval processor 121 sending an outcome 643 for receiving by a host 105 pertinent receiving node (comprising code driven processor and memory mounted application server or control system, as examples); wherein, access device 185 forbidding actuating the operative state from locked to unlocked. As an option, outcome 643 may include an alert with status indicator “invalid” and is recorded in data storage medium 122 by ascertainer 108. The receiving node may comprise a tenant, landlord, property operator, facility operator, employee and visitor.

In an alternative embodiment at block 3, computing device 189 sends to ascertainer 108 at a validation time tᵥ an activation request message 112—pertaining to activating an access device 185 state change operation. Ascertainer 108 transports the activation request message 112 to mobility 183 at block 4, wherein, ascertainer 108 sends to computing device 189 a mobility 183 request pertaining to capturing and sending real-time imaging of the computing device 189 user. At block 5, mobility 183 sends to ascertainer 108 a status indicator “valid”; in contrary at block 6, mobility 183 sends to ascertainer 108 a status indicator “invalid”. At block 7, ascertainer 108 generating and transmitting over network 109 through a selected environment 600 installed AP 107 an outcome, comprising:
commanding signal 644 for a status indicator “valid” to the access device 185, access device 185 actuating the operative state from locked to unlocked; or,
outcome 643 for a status indicator “invalid” to the computing device 189, access device 185 forbidding actuating the operative state from locked to unlocked.

FIG. 8 presents a flow diagram of an embodiment in furtherance of a process 840 in conjunction with FIGS. 2B, 3, 4C, 5A, 5C, and 6A. Processing logic resides in a few entities and apparatuses as discussed hereinafter.

At block 1: facilitator 103 (automobile owner, automobile rental operator, property operator, tenant, as examples) issues an account (ownership account, membership account or rental account with validity throughout a time period, as examples) pertaining to an access device 185 equipped host 105; ascertainer 108 associates a mobility 183 (comprising controller 240) and the host 105 equipped access device 185 as peering related by recording in the data storage medium 122 stored client device IP database 10.1 a mobility 183 identifier (phone number, as an example) and information for authorization of activation of operative state change (“actuation”) of collateral apparatuses 487.1 and 487.2 (not shown) through controlling access device 185, comprising:
collateral apparatus 487.1—operative state 1 pertaining to mechanism position allowing opening of a door in which it is embedded; operative state 2 pertaining to mechanism position locking the door in position;
collateral apparatus 487.2—operative state 1 constituting to operating a appliance, machine; operative state 2 constituting to not operating the appliance, machine.

Collateral apparatus 487.1 generally comprises a control mechanism of an automobile door lock, door of a flat, or door of a safe. As examples, collateral apparatus 487.2 may attribute to the power circuit of an appliance (lights, oven, heating or cooling system, security system, as examples) or relay controlling the operative mode of an appliance; or, an automobile electronic or electrical starting system of an engine propelled by electrical cell, fuel cell, or gasoline, or a hybrid combination of which; wherein, operative state 1 constitutes to power generation mechanism in dynamic state to propel host 105 as automobile to travel in displacement, whereas, operative state 2 constitutes to power generation mechanism in static state to disable host 105 from travel in displacement. In furtherance, access device 185 is a network linked programmable processor mounted control unit, or a central control hub, capable of processing data and controlling the operative state of collateral apparatuses 487.1 and 487.2 in host 105 as an automobile, a house, a flat unit, a safe.

At block 2, mobility 183 approaches host 105 in an environment 600; host 105 is equipped with access device 185, which has the capability to process data communication with ascertainer 108 through the communicatively linked AP 107—which has the capability to provide short-range wireless linkage 319 (using Bluetooth™, WiFi, as examples) and access to network 109. Mobility 183 sends at validation time tᵥ via short-range wireless linkage 319 to the communicatively paired AP 107 linked access device 185 an actuation request—comprising transmitted signals—for actuation in operative state change of collateral apparatus 487.1, or collateral apparatus 487.2, from operative state 2 to 1. Host 105 pertinent access device 185 is configured to receive geo-location system 133 sent signals and calculate the pertinent geo-location data for obtainment of the geo-location (“actuation location dᵥ”) within a time threshold from validation time tᵥ, or AP 107 identifier 502 “NET_GEAR90EE”, and send as proximity data for receiving by ascertainer 108—encompassed in validation request message 110, or in a separate message—during processing a mobility 183 pertinent operation.

Ascertainer 108 receives a mobility 183 account and host 105 pertinent validation request message 110—generated and sent by mobility 183, or, access device 185—comprising selected mobility 183 account information and the corresponding proximity data. Ascertainer 108 acknowledges validation request message 110 as request for verification of relevance of a validation time tᵥ based host 105 pivotal access device 185 actuation request to the mobility 183 account.

At block 3, ascertainer 108 sends to access device 185 message 641.2—comprising selected or all information of mobility 183 proximity data; or, ascertainer 108 sends to mobility 183 message 641.4—comprising selected or all information of access device 185 pertinent proximity data.

Mobility 183 proximity data, comprising any one or combination of:
present position dₙ of mobility 183;
one or more positions dₙ of the controller 240 memory 242 stored user blockchains path 520 recorded with respect to time in controller 240 memory 242 within a time threshold from the validation time tᵥ;
venue AP list 500 recorded with respect to time in a memory within a time threshold from the validation time tᵥ;
proximity log 337.

Access device 185 proximity data, comprising any of:
actuation location dᵥ—access device 185 is configured to receive geo-location system 133 sent signals and calculate the present geo-location data;
venue AP list 500 recorded with respect to time in a memory within a time threshold from the validation time tᵥ;
identifier 502 “NET_GEAR90EE” of access device 185 equipped AP 107.

At block 4, either ascertainer 108, or mobility 183, or access device 185, performs the user validation process by validating the relevance of the mobility 183 proximity data to access device 185 proximity data, comprising any one or combination of the following:
determining whether the distance between actuation location dᵥ and mobility 183 position dₙ recorded at a time within a time threshold from validation time tᵥ, is within or exceeds proximity threshold 525;
validating the relevance of mobility 183 pertinent venue AP list 500 to access device 185 pertinent venue AP list 500;
validating the relevance of the mobility 183 obtained present venue AP list 500, to access device 185 pertinent identifier 502 “NET_GEAR90EE”;
determining whether proximity log 337 is “proximate”.

At block 5, as acknowledgment of relevance of the actuation request to mobility 183 account, either ascertainer 108, or mobility 183, or access device 185, concludes the user validation process with a status indicator “valid”, comprising any one or combination of the following:
distance between the actuation location dᵥ and mobility 183 position d₄ (as an example) recorded at a time within a time threshold from validation time tᵥ, is within proximity threshold 525;
ascertained relevance of mobility 183 pertinent venue AP list 500 to access device 185 pertinent venue AP list 500—both comprising at least one AP 107 identifier in commonality;
mobility 183 pertinent venue AP list 500 comprising identifier 502 “NET_GEAR90EE” of access device 185 equipped AP 107;
proximity log 337 as “proximate”—mobility 183 is communicatively paired with access device 185 equipped AP 107.

In contrary at block 6, either ascertainer 108, or mobility 183, or access device 185, concludes the user validation process with a status indicator “invalid”, comprising any one of the following:
distance between the actuation location dᵥ and mobility 183 position d₈ (as an example) recorded at a time within a time threshold from validation time tᵥ, exceeds proximity threshold 525;
mobility 183 pertinent venue AP list 500 is irrelevant to access device 185 pertinent venue AP list 500—without any AP 107 identifier in commonality;
identifier 502 “NET_GEAR90EE” of access device 185 equipped AP 107 is unavailable in mobility 183 pertinent venue AP list 500;
proximity log 337 is not “proximate”—mobility 183 is not communicatively paired with access device 185 equipped AP 107.

In the event that access device 185 performs the user validation process, access device 185 sends through network 109 to ascertainer 108 a response message 642.2 comprising a status indicator “valid”, or, a status indicator “invalid”. In the event that mobility 183 performs the user validation process, mobility 183 sends through network 109 to ascertainer 108 a response message 642.4 comprising a status indicator “valid”, or, a status indicator “invalid”: ascertainer 108 concludes the user validation process with a status indicator “invalid”, when receiving multiple response messages 642.1 or response messages 642.4; or, not receiving response messages 642.1, 642.4.

At block 7, ascertainer 108 sends through network 109 to mobility 183, access device 185, an outcome 643, comprising:
status indicator “valid”—access device 185 actuating collateral apparatus 487.1 from operative state 2 to operative state 1, authorizing actuation of collateral apparatus 487.2 from operative state 2 to operative state 1; or,
status indicator “invalid”—access device 185 forbidding actuation of collateral apparatus 487.1 from operative state 2 to operative state 1, forbidding actuation of collateral apparatus 487.2 from operative state 2 to operative state 1.

As an option, outcome 643 may include an alert with status indicator “invalid” while access device 185 triggers a siren (not shown), and ascertainer 108 records in data storage medium 122. Access device 185 performs the mobility 183 actuation request in accordance with a status indicator “valid”; access device 185 rejects the mobility 183 requested actuation in accordance with status indicator “invalid”, in an option, triggers an alert.

In a further embodiment, as host 105 incumbent AP 107 paired, via short-range wireless linkage 319, mobility 183—ascertainer 108 acknowledged pertinent to host 105—traverses away from host 105 in distance beyond a proximity threshold corresponding to the effective pairing range, the pairing linkage is dislodged. In accordance with an operating protocol, access device 185 actuates collateral apparatuses 487.1, 487.2, to change an effective operative state 1 to operative state 2.

In a yet further embodiment, mobility 183 is unassociated with facilitator 103 and therefore host 105; host 105 pertinent or access device 185 communicatively linked computing device 189 displays a QR code 616 encrypted payment sum ($10.00, as an example) for settlement, which must be settled and paid with an issuer 104 issued mobility 183 account (bank account, payment card, credit card account, as examples)—access device 185 actuates the collateral apparatus 487.1 to change from operative state 2 to operative state 1 after receiving a message through network 109 from a host 105 pertinent acquirer bank 103 as confirmation of processed payment transaction, in accordance with an outcome 643 with status indicator “valid”, assuring full settlement of the outstanding payment has been transferred from the mobility 483 account to a host 105 pertinent acquirer bank 103 account.

FIG. 8 presents a flow diagram of an embodiment in furtherance of a process 850 in conjunction with FIGS. 2B, 6A, and 6C. Processing logic resides in a few entities and apparatuses as discussed hereinafter.

At block 1, ascertainer 108 receives from a plurality of client application 250 imbedded mobilities 183.1, 183.2, 183.3, 183.4, 183.5, information of accounts (comprising account names and numbers, as examples) respectively issued by issuers 104.1, 104.2, 104.3, 104.4, 104.5; in one embodiment, ascertainer 108 ascertains the accounts information with the plurality of issuers 104.1-5; ascertainer 108 may also ascertain the addresses of accounts by tracking the venue related locations of mobilities 183.1-5 in accordance with the second threshold as previously discussed.

At block 2, mobility 183.5 as administrator of client application 250 corresponded and operated communications group 680 receives from mobilities 183.1-4, a request, or a response to a mobility 183.5 prompted request, to participate; mobility 183.5 accepts mobility 183.4 as non-paying participant, which may exit from communications group 680 at will, and accepts mobilities 183.1-3, as paying participants, which require authorization by mobility 183.5 to exit from communications group 680. Number of non-paying participant is therefore 1, while number of paying participants is 3.

In an exemplary embodiment at block 3, mobility 183.1 enters to communications group 680 pricing figure 681—item of personal use.

At block 4, mobility 183.5 unicasts to the paying participants in accordance with a settlement sum 685 ($100 as an example)—either entered by mobility 183.5, or, imported by importer 253 of mobility 183.5 imbedded client application 250 as sent by a merchant 105, comprising:
subsum 691 to mobility 183.1=(sum 685−pricing figure 681)/4+pricing figure 681;
subsum 692 to mobility 183.2=(sum 685−pricing figure 681)/4;
subsum 693 to mobility 183.3=(sum 685−pricing figure 681)/4.

At block 5, mobility 183.1 settles the subsum 691 through the web site or URL of issuer 104.1 in communications group 680; communications group 680 has a web browser functionality, comprising:
selecting administrator 686—retrieving the registered mobility 183.5 account number and issuer 104.5 code as input of receiving account;
selecting payable 688—retrieving the subsum 691 for transfer from issuer 104.1 pertinent mobility 183.1 account to issuer 104.5 pertinent mobility 183.5 account in receiving 689.

At block 6, mobility 183.2 ignores a prompted request of settlement.

At block 7, communications group 680 is displayed by display & I/O 244 on mobilities 183.1-5, comprising completion of transfer 683.

In one aspect, the accounts comprise savings accounts, payment card accounts, credit card accounts; ascertainer 108 receives confirmation of the subsum 691 transfer from issuer 104.1—ascertainer 108 ascertains mobility 183.5 and other participants through communications group 680 that mobility 183.1 has transferred the subsum 691 from an issuer 104.1 pertinent mobility 183.1 account to the issuer 104.5 pertinent mobility 183.5 account.

### Alert Trigger Policy

Ascertainer 108 activates an alert and sends, in accordance with an alert trigger process, to any one or combination of aforementioned distinct receiving nodes, comprising: (1) instant communication message; (2) notification via Email; (3) notification via an automatic telephone voice; (4) notification via a multimedia message; (5) activation of a siren installed at a host 105; (6) activation of an access device 185 equipped siren; (7) recording a processed alert trigger to the data storage medium 122.

### Short-Range Wireless Communication

As described herein, short-range wireless communication over the wireless communication path may use any of a variety of different physical and protocol layer communication methods. For example, the communication technology may include optical, infrared, radio transmission, RFID, or any other suitable communication technology, and may incorporate IEEE 802.11, 802.15, Bluetooth™, PCS, WiFi, or any other suitable communication method, standard. Account

The discussed embodiments may also include other host 105 (any organization requiring personal identification such as a library, government, airplane, vessel, docking berth, building pass, land pass, merchandise vendor, etc.) acknowledged or issued mobility 183 account (identification card, driver's license, shopper's payment card, as examples).

One skilled in the art will recognize that the above-described aspects, features, embodiments and advantages are intended to be illustrative, are therefore strictly illustrative and do not attribute to limitations of the appended claims except where explicitly recited in a claim(s)—which can be practiced according to embodiments that are combined, so that activation by one mechanism can be followed or substituted by another mechanism. For example, a user account may be issued by an issuer, a facilitator, a third party, or an ascertainer; while an access device may be under operation of a host, an issuer or a facilitator. Web browsing history, transaction location ascertainment and user blockchains path may be enacted in any embodiment without limitation in sequence and numeration. In furtherance, an access device may be substituted by a communication device with or without telematics functionality.

In the specification, certain components of the invention may be described in terms of algorithms and/or steps performed by a software application. In many cases, such descriptions are intended to set forth the invention using representations that are commonly used among those of skill in the arts. Accordingly, various terms such as “ascertaining”, “determining”, “calculating”, “processing”, or the like, may be used herein. Such terms are intended to refer to processes performed by a software and/or hardware device such as a computer system. Furthermore, the invention can be implemented as or in combination of a method, system, computer program product, smartphone, software app with functionality in application, user interface, ATM, automobile navigation system, automobile door lock system, electronic door lock, turnstile gate, POS terminal, smart home control hub, or any combination thereof.

1. A method of verifying account pivotal operations, comprising:
obtaining information pertaining to a mobile device associated account pertinent operation;
obtaining proximity data for an account associated mobile device pertinent operation; or,
obtaining mobility data of an account associated mobile device pertaining to an operation;
determining pertinence of the mobile device associated account and an operation in accordance with the obtained account associated mobile device pertinent proximity data; or,
determining pertinence of a mobile device associated account and an operation in accordance with the obtained account associated mobile device pertinent mobility data.

2. The method of claim 1, obtaining information pertaining to a mobile device associated account pertinent operation, comprising any one of:
receiving information pertaining to transfer of credit with a mobile device associated account;
receiving information pertaining to actuate in change of operative state of an apparatus with a mobile device associated account.

3. The method of claim 1, obtaining proximity data for an account associated mobile device pertinent operation, comprising any one or combination of:
receiving a present geographic location of a device performing an operation pertaining to a mobile device pertinent account;
receiving a present list of short-range wireless access points for provision of communicative linkage captured by a device performing an operation pertaining to a mobile device pertinent account;
sending to the account associated mobile device the present geographic location of a device performing an operation pertaining to the mobile device pertinent account;
sending to the account associated mobile device a device the present list of short-range wireless access points for provision of communicative linkage captured by a device performing an operation pertaining to a mobile device pertinent account.

4. The method of claim 1, obtaining proximity data for an account associated mobile device pertinent operation, further comprising any one or combination of:
sending a message to the mobile device a request for the present geographic location of the mobile device;
sending a message to the mobile device a request for the present list of short-range wireless access points for provision of communicative linkage;
receiving from the mobile device a geographic location obtained by the mobile device within a time threshold from the juncture of the operation;
receiving the mobile device pertinent present list of short-range wireless access points for provision of communicative linkage.

5. The method of claim 1, obtaining mobility data of an account associated mobile device, comprising:
sending a message to an account associated mobile device a request for records pertaining to web sites browsed during a time period;
receiving from the mobile device records pertaining to web sites browsed during a time period.

6. The method of claim 1, obtaining mobility data of an account associated mobile device, further comprising any one or combination of:
sending a message to an account associated mobile device a request for record of mobile device associated account pertinent message transported to a receiving node;
sending a message to an account associated mobile device a request for record of a code for performing a mobile device associated account pertinent operation;
receiving from the mobile device record of mobile device associated account pertinent message transported to the receiving node;
receiving from the mobile device record of a code for performing a mobile device associated account pertinent operation.

7. The method of claim 1, determining pertinence of a mobile device associated account and an operation in accordance with the obtained account associated mobile device pertinent proximity data, comprising any one or combination of:
determining whether a distance of the geographic location of the mobile device, recorded within a time threshold from the juncture of the operation, from the geographic location of a device performing a location of operation is within or exceeds a proximity threshold;
ascertaining whether one or more identifiers of access points are in commonality between the list of short-range wireless access points for provision of communicative linkage recorded by the device—within a time threshold from the juncture of the operation—performing an operation pertaining to the mobile device pertinent account, and, the present list of short-range wireless access points for provision of communicative linkage recorded by the mobile device—within a time threshold from the juncture of the operation.

8. The method of claim 1, determining pertinence of a mobile device associated account and an operation in accordance with the obtained account associated mobile device pertinent mobility data, comprising:
verifying the relevance of account associated mobile device sent records pertaining to web sites browsed during a time period within a time threshold from the validation time tᵥ, to the operation entailed web site(s).

9. The method of claim 1, determining pertinence of a mobile device associated account and an operation in accordance with the obtained account associated mobile device pertinent mobility data, further comprising any one of:
verifying the relevance of an account associated mobile device sent record of mobile device associated account pertinent message transported to the receiving node to an operation pertinent record;
verifying the relevance of an account associated mobile device sent record of a code for performing a mobile device associated account pertinent operation to an operation pertinent code.

10. The method of claim 1, obtaining information pertaining to a mobile device associated account pertinent operation, comprising any one or combination of:
associating a mobile device to an account;
associating a computing device to a mobile device as peering device.

11. A system of verifying account pivotal operations, comprising:
multiple processors mounted application servers;
memory, working with or within the communicatively coupled processor mounted application servers, storing instructions and coding, when executed by the one or more processors, are configured to perform operations of the following;
obtaining information pertaining to a mobile device associated account pertinent operation;
obtaining proximity data for an account associated mobile device pertinent operation; or,
obtaining mobility data of an account associated mobile device pertaining to an operation;
determining pertinence of the mobile device associated account and an operation in accordance with the obtained account associated mobile device pertinent proximity data; or,
determining pertinence of a mobile device associated account and an operation in accordance with the obtained account associated mobile device pertinent mobility data.

12. The system of claim 11, obtaining information pertaining to a mobile device associated account pertinent operation, comprising any one of:
receiving information pertaining to transfer of credit with a mobile device associated account;
receiving information pertaining to actuate in change of operative state of an apparatus with a mobile device associated account.

13. The system of claim 11, obtaining proximity data for an account associated mobile device pertinent operation, comprising any one or combination of:
receiving a present geographic location of a device performing an operation pertaining to a mobile device pertinent account;
receiving a present list of short-range wireless access points for provision of communicative linkage captured by a device performing an operation pertaining to a mobile device pertinent account;
sending to the account associated mobile device the present geographic location of a device performing an operation pertaining to the mobile device pertinent account;
sending to the account associated mobile device a device the present list of short-range wireless access points for provision of communicative linkage captured by a device performing an operation pertaining to a mobile device pertinent account.

14. The system of claim 11, obtaining proximity data for an account associated mobile device pertinent operation, further comprising any one or combination of:
sending a message to the mobile device a request for the present geographic location of the mobile device;
sending a message to the mobile device a request for the present list of short-range wireless access points for provision of communicative linkage;
receiving from the mobile device a geographic location obtained by the mobile device within a time threshold from the juncture of the operation;
receiving the mobile device pertinent present list of short-range wireless access points for provision of communicative linkage.

15. The system of claim 11, obtaining mobility data of an account associated mobile device, comprising:
sending a message to an account associated mobile device a request for records pertaining to web sites browsed during a time period;
receiving from the mobile device records pertaining to web sites browsed during a time period.

16. The system of claim 11, obtaining mobility data of an account associated mobile device, further comprising any one or combination of:
sending a message to an account associated mobile device a request for record of mobile device associated account pertinent message transported to a receiving node;
sending a message to an account associated mobile device a request for record of a code for performing a mobile device associated account pertinent operation;
receiving from the mobile device record of mobile device associated account pertinent message transported to the receiving node;
receiving from the mobile device record of a code for performing a mobile device associated account pertinent operation.

17. The system of claim 11, determining pertinence of a mobile device associated account and an operation in accordance with the obtained account associated mobile device pertinent proximity data, comprising any one or combination of:
determining whether a distance of the geographic location of the mobile device, recorded within a time threshold from the juncture of the operation, from the geographic location of a device performing a location of operation is within or exceeds a proximity threshold;
ascertaining whether one or more identifiers of access points are in commonality between the list of short-range wireless access points for provision of communicative linkage recorded by the device—within a time threshold from the juncture of the operation—performing an operation pertaining to the mobile device pertinent account, and, the present list of short-range wireless access points for provision of communicative linkage recorded by the mobile device—within a time threshold from the juncture of the operation.

18. The system of claim 11, determining pertinence of a mobile device associated account and an operation in accordance with the obtained account associated mobile device pertinent mobility data, comprising:
verifying the relevance of account associated mobile device sent records pertaining to web sites browsed during a time period within a time threshold from the validation time tᵥ, to the operation entailed web site(s).

19. The system of claim 11, determining pertinence of a mobile device associated account and an operation in accordance with the obtained account associated mobile device pertinent mobility data, further comprising any one of:
verifying the relevance of an account associated mobile device sent record of mobile device associated account pertinent message transported to the receiving node to an operation pertinent record;
verifying the relevance of an account associated mobile device sent record of a code for performing a mobile device associated account pertinent operation to an operation pertinent code.

20. The system of claim 11 obtaining information pertaining to a mobile device associated account pertinent operation, comprising any one or combination of:
associating a mobile device to an account;
associating a computing device to a mobile device as peering device.
